(19) United States
(12) Patent Application Publication
(10) Pub. No.: US 2025/0296378 A1
(43) Pub. Date: Sep. 25, 2025

(54) TEST PATTERN FORMING METHOD

(71) Applicant: SCREEN Holdings Co., Ltd., Kyoto (JP)

(72) Inventor: Keigo SHIMIZU, Kyoto-shi (JP)

(21) Appl. No.: 19/036,116

(22) Filed: Jan. 24, 2025

(30) Foreign Application Priority Data
Mar. 22, 2024 (JP) 2024-046030

(51) Int. Cl. B41M 3/00; B41J 2/21; B41J 11/00; B41M 7/00

(52) U.S. Cl. CPC B41M 3/008; B41J 2/2103; B41J 2/2135; B41J 2/2142; B41J 11/00214; B41M 7/0081

(57) ABSTRACT

A primer is ejected to a first region on a print medium. Thereafter, the primer is cured by ultraviolet light. Next, a colored ink is ejected to a second region including the first region and a peripheral region of the first region. At this time, the colored ink is ejected from the colored ink ejection head so that a printing rate is 70% or more and a height of a liquid level of the colored ink in the peripheral region of the first region is 70% or more of a height of a liquid level of the primer in the first region. Thereafter, the colored ink is cured by ultraviolet light.

### BACKGROUND OF THE INVENTION

### Field of the Invention

The present invention relates to a method of forming, on a print medium, a test pattern for inspecting an ejection state of a primer from a print head in an inkjet printing apparatus that applies the primer to the print medium before printing using a colored ink.

### Description of Related Art

An inkjet printing apparatus that performs printing by ejecting ink onto a print medium such as printing paper and a film is widely known. In the inkjet printing apparatus, printing is generally performed using aqueous ink. However, in recent years, for example, for label printing, development of an inkjet printing apparatus that performs printing using UV ink (ultraviolet curable ink) has advanced. In the inkjet printing apparatus that performs printing using the UV ink, the UV ink is irradiated with UV light (ultraviolet light) in order to fix the UV ink ejected from a print head to a print medium.

In the inkjet printing apparatus as described above, color printing is typically performed using inks of four colors of cyan (C), magenta (M), yellow (Y), and black (K). In this regard, misregistration may occur between a plurality When the misregistration occurs, a good of the colors. printed matter cannot be obtained due to occurrence of moire or the like. Furthermore, in the inkjet printing apparatus, drying of the ink due to evaporation of a solvent in the vicinity of a nozzle, mixing of air bubbles into the nozzle, adhesion of dust to the nozzle, and the like may occur. That is, ejection defects of the nozzle may occur. When the ejection defects of the nozzle occur, for example, a dot missing (missing of a dot corresponding to the ejection defect nozzle) occurs in the print image, and a good printed matter cannot be obtained.

Therefore, conventionally, based on a print image obtained by printing a predetermined test pattern, check of the presence or absence of misregistration and detection of an ejection defect nozzle are performed. Regarding this, first, an example of a test pattern used to check the presence or absence of the misregistration will be described. Here, attention is focused on a test pattern used to check the presence or absence of the misregistration between cyan and magenta, yellow, and black. In this example, a test pattern as schematically illustrated in FIG. 52 is used. In FIG. 52, a region denoted by reference sign 91 is a region to be applied with the cyan ink (hereinafter, the region is referred to as a “cyan region”), a region denoted by reference sign 92 is a region to be applied with the magenta ink (hereinafter, the region is referred to as a “magenta region”), a region denoted by reference sign 93 is a region to be applied with the yellow ink (hereinafter, the region is referred to as a “yellow region”), and a region denoted by reference sign 94 is a region to be applied with the black ink (hereinafter, the region is referred to as a “black region”). As can be grasped from FIG. 52, each of the magenta region 92, the yellow region 93, and the black region 94 has a cross shape. A region excluding the magenta region 92, the yellow region 93, and the black region 94 is the cyan region 91. Here, it is assumed that when printing is actually executed based on test data for forming the test pattern illustrated in FIG. 52, a print image as schematically illustrated in FIG. 53 is obtained. From the print image illustrated in FIG. 53, it can be grasped that misregistration does not occur between cyan and magenta, but misregistration occurs between cyan and yellow and between cyan and black. Furthermore, it is understood that a deviation amount between cyan and black is larger than a deviation amount between cyan and yellow.

Next, an example of a test pattern used for detecting an ejection defect nozzle will be described. When an ejection defect nozzle is detected from among a large number of nozzles included in the print head, a test pattern as schematically illustrated in FIG. 54 is used. With respect to FIG. 54, a black shaded portion is a region where the ink is to be applied by ejecting the ink from the nozzle included in the print head. As can be grasped from FIG. 54, this test pattern is a stepwise pattern including a large number of linear patterns. Each of the linear patterns is a pattern formed by ejecting ink from one corresponding nozzle. Here, it is assumed that when printing is actually executed based on test data for forming the test pattern illustrated in FIG. 54, a print image as schematically illustrated in FIG. 55 is obtained. In a dotted line portion denoted by reference sign 97 in FIG. 55, no ink is applied to a region where ink is to be applied. From this, it can be grasped that ejection defects have occurred in the nozzle that should apply ink to the dotted line portion denoted by reference sign 97 in FIG. 55.

By the way, in the inkjet printing apparatus, the adhesion between the ink and the print medium may become insufficient depending on the type of the print medium. If the adhesion between the ink and the print medium is insufficient, a good printed matter cannot be obtained. Therefore, in order to obtain good adhesion between the ink and the print medium, a transparent treatment liquid called a primer may be applied onto the print medium prior to printing using the ink. Note that, in the following description, in order to clearly distinguish between the ink used for forming the actual print image and the transparent treatment liquid such as the primer, the ink used for forming the actual print image is referred to as “colored ink”.

In connection with the present invention, Japanese Laid-Open Patent Publication No. 2015-182365 discloses a technique of checking a state of application of the overcoat agent inexpensively and easily without using a special overcoat agent, although the technique is related to an inkjet printing apparatus using an overcoat agent as a transparent treatment liquid instead of a primer. According to this technique, an inspecting region is formed on a print medium using a colored ink (for example, cyan ink) in an inspecting discharge mode having a higher printing rate than in a normal discharge mode, and an overcoating inspecting chart is formed by ejecting an overcoat agent onto the inspecting region. Since printing is performed in a substantially solid state in the inspecting region, the uniformity of the colored ink in the inspecting region is enhanced. Furthermore, if the overcoat agent is ejected onto the print medium before the colored ink is absorbed onto the print medium, the colored ink bleeds and the color tone changes. As a result, the visibility of the overcoating inspecting chart is improved, and the state of application of the overcoat agent to the print medium can be checked.

Since the primer is a transparent treatment liquid, even if a test pattern is printed using the primer, it is extremely difficult to check the application state of the primer by visually observing the print image of the test pattern. Furthermore, the technique disclosed in Japanese Laid-Open Patent Publication No. 2015-182365 is a technique using an overcoat agent, and the technique cannot be applied to a case where a primer is applied to a print medium prior to printing using a colored ink. Even if the rough application state of the primer can be grasped based on the bleeding of the colored ink, it is difficult to suitably determine whether or not a difference between the actual application region and the original application region is within an allowable range.

### SUMMARY OF THE INVENTION

Therefore, an object of the present invention is to make it easy to check the application state of the primer on the print medium (ejection state of the primer from the print head) in the inkjet printing apparatus.

One aspect of the present invention is directed to a test pattern forming method of forming a test pattern on a print medium in an inkjet printing apparatus including a colored ink ejection head that ejects a colored ink of ultraviolet curing type and a primer ejection head that ejects a primer of ultraviolet curing type, the test pattern being for inspecting an ejection state of the primer from the primer ejection head, the test pattern forming method including:
ejecting the primer from the primer ejection head toward a first region on the print medium; curing the primer ejected from the primer ejection head with ultraviolet light;
ejecting the colored ink from the colored ink ejection head at a constant ejection amount per unit area toward a second region including the first region and a peripheral region of the first region; and
curing the colored ink ejected from the colored ink ejection head with ultraviolet light,
wherein when a ratio of an amount of the colored ink actually ejected onto the print medium to an amount of the colored ink required to form a solid pattern on the print medium is defined as a printing rate, in the ejecting the colored ink, the colored ink is ejected from the colored ink ejection head such that the printing rate is 70% or more and a height of a liquid level of the colored ink in the peripheral region of the first region is 70% or more of a height of a liquid level of the primer in the first region.

According to such a configuration, when the test pattern for inspecting the ejection state of the primer is formed on the print medium, after the primer ejected from the primer ejection head is cured, the colored ink is ejected from the colored ink ejection head toward the region to which the primer is applied and the peripheral region thereof so that the printing rate of the colored ink is 70% or more and the height of the liquid level of the colored ink in the peripheral region of the region to which the primer is applied is 70% or more of the height of the liquid level of the primer. Thus, at least the colored ink ejected to the edge region among the region to which the primer is applied flows to the periphery, and a layer of the colored ink becomes thinner in the entire region to which the primer is applied or the edge region among the region to which the primer is applied than in other regions. As a result, it is possible to visually check the region to which the primer is applied. Thus, it is possible to easily check the application state of the primer on the print medium in the inkjet printing apparatus. Furthermore, since the occurrence of misregistration and ejection defects at the time of main printing is suppressed by performing the inspection in advance, wasteful consumption of the print medium and the ink is suppressed. In this way, it is possible to contribute to the achievement of the SDGs (sustainable development goals).

Another aspect of the present invention is directed to a test pattern forming method of forming a test pattern on a print medium in an inkjet printing apparatus including a colored ink ejection head that ejects a colored ink of ultraviolet curing type and a primer ejection head that ejects a primer of ultraviolet curing type, the test pattern being for inspecting an ejection state of the primer from the primer ejection head, the test pattern forming method including:
ejecting the primer from the primer ejection head toward a first region on the print medium;
curing the primer ejected from the primer ejection head with ultraviolet light;
ejecting the colored ink from the colored ink ejection head at a constant ejection amount per unit area toward a second region including the first region and a peripheral region of the first region; and
curing the colored ink ejected from the colored ink ejection head with ultraviolet light,
wherein when a ratio of an amount of the colored ink actually ejected onto the print medium to an amount of the colored ink required to form a solid pattern on the print medium is defined as a printing rate, in the ejecting the colored ink, the colored ink is ejected from the colored ink ejection head such that the printing rate is 30% or less, and
a contact angle of the colored ink on the print medium in the peripheral region of the first region is larger than a contact angle of the colored ink on the primer in the first region.

According to such a configuration, when the test pattern for inspecting the ejection state of the primer is formed on the print medium, after the primer ejected from the primer ejection head is cured, the colored ink is ejected from the colored ink ejection head toward the region to which the primer is applied and the peripheral region thereof so that the printing rate of the colored ink is 30% or less. Here, the contact angle of the colored ink on the print medium in the peripheral region of the region to which the primer is applied is larger than the contact angle of the colored ink on the primer. Therefore, the colored ink cures without almost spreading in the peripheral region of the region to which the primer is applied, whereas the colored ink wets and spreads in the region to which the primer is applied, so the region to which the primer is applied looks darker than other regions. That is, it is possible to visually check the region to which the primer is applied. Thus, it is possible to easily check the application state of the primer on the print medium in the inkjet printing apparatus. Furthermore, as in the one aspect of the present invention described above, it is possible to contribute to the achievement of the SDGs (sustainable development goals).

These and other objects, features, modes, and advantageous effects of the present invention will become more apparent from the following detailed description of the present invention with reference to the accompanying drawings.

### BRIEF DESCRIPTION OF THE DRAWINGS

FIG. 1 is a schematic diagram illustrating a configuration example of an inkjet printing apparatus in all embodiments;

FIG. 2 is a plan view schematically illustrating a configuration of a recording unit in all the embodiments;

FIG. 3 is a plan view illustrating a configuration example of a print head in all the embodiments;

FIG. 4 is a diagram for explaining an arrangement of nozzles in a head module in all the embodiments;

FIG. 5 is a block diagram illustrating a configuration for controlling a printing mechanism in all the embodiments;

FIG. 6 is a flowchart for explaining a test pattern forming method in all the embodiments;

FIG. 7 is a diagram schematically illustrating a register adjustment mark formed on a print medium in a first embodiment;

FIG. 8 is a diagram for explaining details of the register adjustment mark in the first embodiment;

FIG. 9 is a diagram for explaining details of the register adjustment mark in the first embodiment;

FIG. 10 is a diagram schematically illustrating a state immediately after a primer is ejected from a primer ejection head in the first embodiment;

FIG. 11 is a diagram schematically illustrating a state immediately after a colored ink is ejected from a colored ink ejection head in the first embodiment;

FIG. 12 is a diagram for explaining a relationship between a height of a liquid level of the colored ink and a height of a liquid level of the primer in the first embodiment;

FIG. 13 is a diagram for explaining a flow distance of the colored ink ejected on the primer in the first embodiment;

FIG. 14 is a diagram schematically illustrating a state after the colored ink on the primer flowed in the first embodiment;

FIG. 15 is a diagram schematically illustrating a print image of a test pattern in a case where a printing rate is suitable in the first embodiment;

FIG. 16 is a diagram schematically illustrating a print image of a test pattern in a case where the printing rate is too low in the first embodiment;

FIG. 17 is a diagram schematically illustrating a print image of a test pattern in a case where the printing rate is too high in the first embodiment;

FIG. 18 is a diagram schematically illustrating a register adjustment mark formed on a print medium in a second embodiment;

FIG. 19 is a diagram for explaining details of the register adjustment mark in the second embodiment;

FIG. 20 is a diagram for explaining details of the register adjustment mark in the second embodiment;

FIG. 21 is a diagram schematically illustrating a state immediately after a primer is ejected from a primer ejection head in the second embodiment;

FIG. 22 is a diagram schematically illustrating a state immediately after a colored ink is ejected from a colored ink ejection head in the second embodiment;

FIG. 23 is a diagram for explaining a relationship between a height of a liquid level of the colored ink and a height of a liquid level of the primer in the second embodiment;

FIG. 24 is a diagram for explaining a flow distance of the colored ink ejected on the primer in the second embodiment;

FIG. 25 is a diagram schematically illustrating a state after the colored ink on the primer flowed in the second embodiment;

FIG. 26 is a diagram schematically illustrating a print image of a test pattern in a case where a printing rate is suitable in the second embodiment;

FIG. 27 is a partially enlarged view of FIG. 26;

FIG. 28 is a diagram schematically illustrating a first register adjustment pattern that is one of register adjustment formed on a print medium in a third embodiment;

FIG. 29 is a diagram schematically illustrating a second register adjustment pattern that is another one of the register adjustment marks formed on the print medium in the third embodiment;

FIG. 30 is a diagram schematically illustrating a state immediately after a primer is ejected from a primer ejection head in the third embodiment;

FIG. 31 is a diagram for explaining a contact angle of a colored ink in the third embodiment;

FIG. 32 is a diagram for explaining a dot diameter of the colored ink in the third embodiment;

FIG. 33 is a diagram for explaining the dot diameter of the colored ink in the third embodiment;

FIG. 34 is a diagram schematically illustrating a state after the colored ink on the primer flowed in the third embodiment;

FIG. 35 is a diagram illustrating a result of an experimental example in which the primer was applied to a first region and then the colored ink was applied at a printing rate of 20% on an upper surface of the print medium, regarding the third embodiment;

FIG. 36 is a diagram schematically illustrating a first register adjustment pattern that is one of register adjustment marks formed on a print medium in a fourth embodiment;

FIG. 37 is a diagram schematically illustrating a second register adjustment pattern that is another one of the register adjustment marks formed on the print medium in the fourth embodiment;

FIG. 38 is a partially enlarged view of a gap region located between a first figure and a second figure constituting the first register adjustment pattern in the fourth embodiment;

FIG. 39 is a partially enlarged view of a gap region located between a third figure and a fourth figure constituting the second register adjustment pattern in the fourth embodiment;

FIG. 40 is a diagram schematically illustrating a register adjustment mark formed on a print medium in a first modification;

FIG. 41 is a diagram for explaining details of the register adjustment mark in the first modification;

FIG. 42 is a diagram schematically illustrating a print image of a test pattern when a printing rate is set to 70 to 200% in the first modification;

FIG. 43 is a diagram schematically illustrating a print image of a test pattern when the printing rate is set to 10 to 30% in the first modification;

FIG. 44 is a diagram schematically illustrating an ejection defect nozzle detection pattern formed on a print medium in a second modification;

FIG. 45 is a diagram for explaining details of the ejection defect nozzle detection pattern in the second modification;

FIG. 46 is a diagram for explaining details of the ejection defect nozzle detection pattern in the second modification;

FIG. 47 is a diagram for explaining a flow distance of a colored ink ejected on a primer in the second modification;

FIG. 48 is a diagram schematically illustrating a print image of a test pattern in a case where a printing rate is set to 70 to 200% and an ejection defect nozzle is not present in the second modification;

FIG. 49 is a diagram schematically illustrating an example of a print image of a test pattern in a case where the printing rate is set to 70 to 200% and the ejection defect nozzle is present in the second modification;

FIG. 50 is a diagram schematically illustrating a print image of a test pattern in a case where the printing rate is set to 10 to 30% and the ejection defect nozzle is not present in the second modification;

FIG. 51 is a diagram schematically illustrating an example of a print image of a test pattern in a case where the printing rate is set to 10 to 30% and the ejection defect nozzle is present in the second modification;

FIG. 52 is a diagram schematically illustrating an example of a test pattern used to check the presence or absence of misregistration in a conventional example;

FIG. 53 is a diagram schematically illustrating an example of a print image of a test pattern when misregistration occurs in the conventional example;

FIG. 54 is a diagram schematically illustrating an example of a test pattern used to detect an ejection defect nozzle in the conventional example; and

FIG. 55 is a diagram schematically illustrating an example of a print image of a test pattern when an ejection defect occurs in a conventional example.

### DETAILED DESCRIPTION OF PREFERRED EMBODIMENTS

Hereinafter, embodiments of the present invention will be described with reference to the accompanying drawings. Note that, first, matters common to all the embodiments (including modifications) will be described, and then, four embodiments (first to fourth embodiments) and two modifications (first and second modifications) will be described.

### <1. Configuration of Inkjet Printing Apparatus>

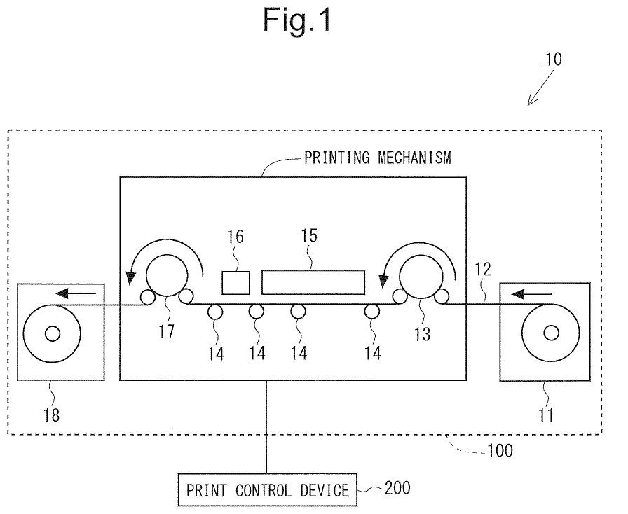

FIG. 1 is a schematic diagram illustrating a configuration example of an inkjet printing apparatus 10 in all embodiments (including modifications). The inkjet printing apparatus 10 is a printing apparatus that uses an ultraviolet curable colored ink and an ultraviolet curable primer during printing. That is, the inkjet printing apparatus 10 is a printing apparatus capable of applying a primer, which is a transparent treatment liquid, to a print medium 12 before printing using a colored ink.

The inkjet printing apparatus 10 includes a printing machine body 100 and a print control device 200. The printing machine body 100 includes a print medium feeding unit 11 that supplies a print medium (printing paper, film, or the like) 12 to a printing mechanism, a first drive roller 13 that conveys the print medium 12 to the inside of the printing mechanism, a plurality of support rollers 14 that convey the print medium 12 in the inside of the printing mechanism, a recording unit 15 that records an image on the print medium 12 by ejecting a colored ink onto the print medium 12 and curing the colored ink ejected onto the print medium 12, an imaging unit 16 that images a print image (print medium 12 after printing), a second drive roller 17 that outputs the print medium 12 from the inside of the printing mechanism, and a print medium winding unit 18 that winds the print medium 12 after printing. The recording unit 15 is configured to be able to eject the primer onto the print medium 12 and cure the primer ejected onto the print medium 12 before ejecting the colored ink onto the print medium 12. The print control device 200 controls an operation of the printing machine body 100 having the above configuration.

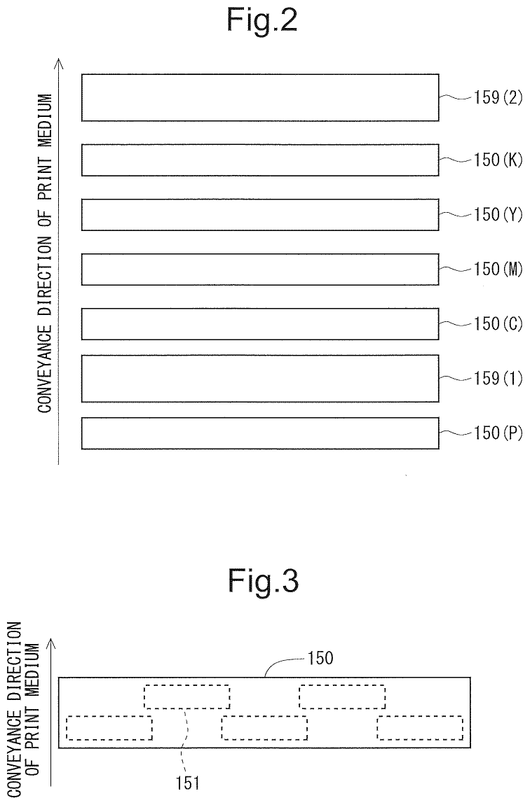

FIG. 2 is a plan view schematically illustrating a configuration of the recording unit 15. The recording unit 15 includes a primer ejection head 150(P) that is a print head that ejects a primer, a UV-LED 159(1) that cures the primer ejected on the print medium 12 by ultraviolet irradiation, a cyan ink ejection head 150(C) that is a print head that ejects a cyan ink, a magenta ink ejection head 150(M) that is a print head that ejects a magenta ink, a yellow ink ejection head 150(Y) that is a print head that ejects a yellow ink, a black ink ejection head 150(K) that is a print head that ejects a black ink, and a UV-LED 159(2) that cures colored inks (cyan ink, magenta ink, yellow ink, and black ink) ejected on the print medium 12 by ultraviolet irradiation. Note that, hereinafter, the cyan ink ejection head 150(C), the magenta ink ejection head 150(M), the yellow ink ejection head 150(Y), and the black ink ejection head 150(K) are collectively referred to as “colored ink ejection heads”. The primer ejection head 150(P) is disposed upstream of the colored ink ejection heads in a conveyance direction of the print medium 12.

Since the print medium 12 is conveyed from the lower side to the upper side in FIG. 2, the primer is first ejected toward the print medium 12, and the primer is cured by the UV-LED 159(1). Then, the cyan ink, the magenta ink, the yellow ink, and the black ink are sequentially ejected toward the print medium 12, and the cyan ink, the magenta ink, the yellow ink, and the black ink are cured by the UV-LED 159(2).

FIG. 3 is a plan view illustrating a configuration example of one print head 150. The print head 150 includes a plurality of head modules 151 arranged in a staggered manner. Each of the head modules 151 includes a large number of nozzles (not illustrated) for ejecting the colored ink or the primer.

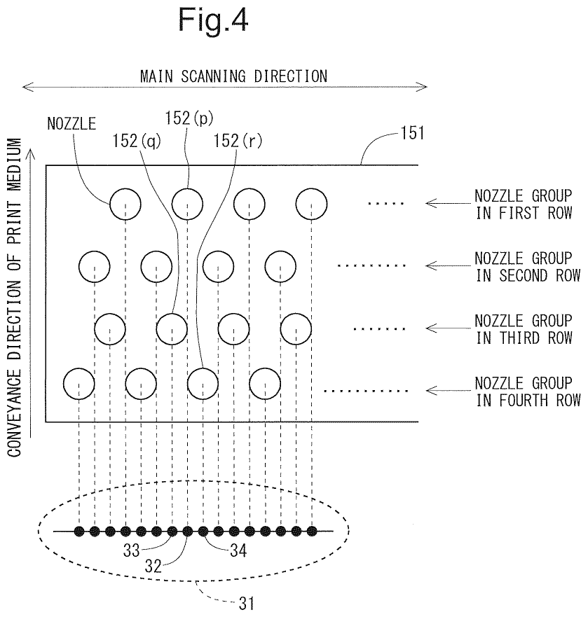

FIG. 4 is a diagram for explaining an arrangement of the nozzles in the head module 151. Typically, the head module 151 includes a plurality of rows of nozzle groups each including a plurality of nozzles arranged side by side in a main scanning direction (direction orthogonal to the conveyance direction of the print medium 12). In the example illustrated in FIG. 4, four rows of nozzle groups are included in the head module 151. A portion denoted by reference sign 31 in FIG. 4 schematically illustrates landing positions on the print medium 12 of the ink ejected from respective nozzles. The plurality of nozzles in the head module 151 are arranged so that the landing positions of the ink ejected from the nozzles included in the nozzle group in the first row, the landing positions of the ink ejected from the nozzles included in the nozzle group in the second row, the landing positions of the ink ejected from the nozzles included in the nozzle group in the third row, and the landing positions of the ink ejected from the nozzles included in the nozzle group in the fourth row are different positions. For example, the landing position of the ink ejected from each nozzle included in the nozzle group in the first row is a position between the landing position of the ink ejected from the nozzle included in the nozzle group in the third row and the landing position of the ink ejected from the nozzle included in the nozzle group in the fourth row. In the example illustrated in FIG. 4, the landing position 32 of the ink ejected from the nozzle denoted by reference sign 152(p) is a position between the landing position 33 of the ink ejected from the nozzle denoted by reference sign 152(q) and the landing position 34 of the ink ejected from the nozzle denoted by reference sign 152(r). Hereinafter, the pair of nozzles 152 (for example, the nozzle 152(p) and the nozzle 152(q), and the nozzle 152(p) and the nozzle 152(r)) forming the pair of landing positions (for example, the landing position 32 and the landing position 33, and the landing position 32 and the landing position 34) adjacent in the main scanning direction on the print medium 12 may be referred to as “adjacent nozzles” (each of the adjacent nozzles is also denoted by reference sign 152). Furthermore, an interval of the adjacent nozzles 152 in the main scanning direction in the head module 151 may be referred to as a “nozzle pitch”. The nozzle pitches of the plurality of nozzles 152 in the same head module 151 are basically the same. In the present embodiment, a nozzle pitch in the colored ink ejection heads 150 and a nozzle pitch in the primer ejection head 150(P) are the same. However, the primer is not required to have a higher recording resolution than the colored ink. Therefore, the nozzle pitch in the primer ejection head 150(P) may be wider than the nozzle pitch in the colored ink ejection heads 150.

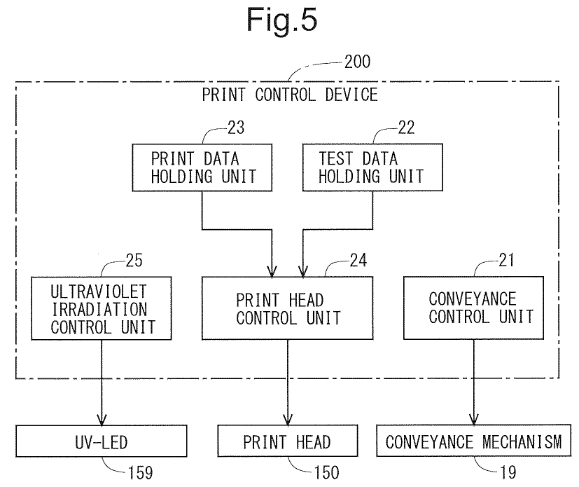

FIG. 5 is a block diagram illustrating a configuration for controlling the printing mechanism. The print control device 200 includes a conveyance control unit 21, a test data holding unit 22, a print data holding unit 23, a print head control unit 24, and an ultraviolet irradiation control unit 25 as components related to the present invention among the components for controlling the printing mechanism. Note that these components are implemented by a program for print control being executed by a computer inside the print control device 200.

The conveyance control unit 21 controls a speed (conveyance speed) at which a conveyance mechanism 19 conveys the print medium 12. Note that the conveyance mechanism 19 that conveys the print medium 12 in a predetermined conveyance direction is realized by the print medium feeding unit 11, the first drive roller 13, the plurality of support rollers 14, the second drive roller 17, and the print medium winding unit 18 (see FIG. 1). The test data holding unit 22 holds test data (data that is a source of a test pattern to be formed on the print medium 12) representing a test pattern for inspecting an ejection state of the colored ink or the primer from the print heads 150. The print data holding unit 23 temporarily holds the print data after a rasterization process transmitted from the outside. The print head control unit 24 generates halftone image data by performing a halftone process on the test data held in the test data holding unit 22 or the print data held in the print data holding unit 23, and controls the ejection of the colored ink or the primer from each nozzle included in each print head 150 constituting the recording unit 15 on the basis of the halftone image data. The ultraviolet irradiation control unit 25 controls the intensity of ultraviolet irradiation by each UV-LED 159 constituting the recording unit 15.

Note that each of the configurations illustrated in FIGS. 1 to 5 is an example, and various other configurations can be adopted. For example, a print head that ejects a white ink or a print head that ejects a spot color ink may be included in the recording unit 15. Furthermore, for example, the detailed configuration of the colored ink ejection head and the detailed configuration of the primer ejection head 150(P) may be different.

### <2. Inspection of Ejection State of Primer>

In a case where the inkjet printing apparatus 10 including the primer ejection head 150(P) that ejects the primer is used, an inspection as to whether or not the primer is normally ejected from the primer ejection head 150(P) (in other words, an inspection as to whether or not the primer is normally applied to the print medium 12) is performed as necessary. At the time of inspection, a test pattern is formed on the print medium 12 by the recording unit 15 on the basis of the test data. Then, the inspection operator visually observes the print image of the test pattern formed on the print medium 12 to inspect the ejection state of the primer (the application state of the primer to the print medium 12). In a case where misregistration between the primer and the colored ink is found by the inspection, for example, adjustment of the position of the print head 150 or adjustment of the ejection timing of the primer or the colored ink from each nozzle 152 is performed. Furthermore, in a case where an ejection defect nozzle is detected by inspection, for example, cleaning or flushing of the primer ejection head 150(P) is performed. Note that the ejection state of the primer may be inspected by performing image analysis processing by the computer on the basis of imaging data obtained by imaging the print image of the test pattern formed on the print medium 12 by the imaging unit 16.

### <3. Test Pattern Forming Method>

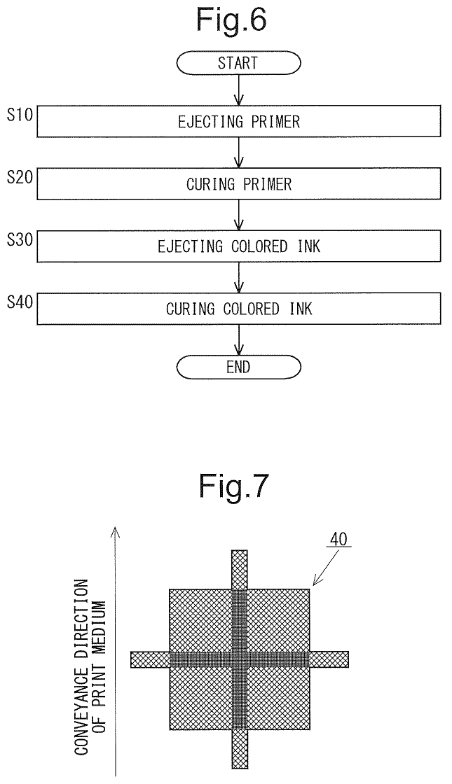

Next, a procedure for forming a test pattern on the print medium 12 will be described with reference to a flowchart illustrated in FIG. 6. First, a primer is ejected from the primer ejection head 150(P) toward the print medium 12 based on the control by the print head control unit 24 (step S10). Then, the UV-LED 159(1) irradiates the print medium 12 with ultraviolet light based on the control by the ultraviolet irradiation control unit 25, whereby the primer ejected from the primer ejection head 150(P) in step S10 is cured (step S20). Thereafter, based on the control by the print head control unit 24, the colored ink is ejected from the colored ink ejection head toward the print medium 12 at a constant ejection amount per unit area (step S30). Then, the UV-LED 159(2) irradiates the print medium 12 with ultraviolet light based on the control by the ultraviolet irradiation control unit 25, whereby the colored ink ejected from the colored ink ejection head in step S30 is cured (step S40). In this way, a test pattern for inspecting the ejection state of the primer from the primer ejection head 150(P) is formed on the print medium 12. Note that, in the following description, a region on the print medium 12 to which the primer is to be applied in step S10 is referred to as a “first region”, and a region on the print medium 12 to which the colored ink is to be applied in step S30 is referred to as a “second region”.

Note that ejecting the primer is realized by step S10, curing the primer is realized by step S20, ejecting the colored ink is realized by step S30, and curing the colored ink is realized by step S40.

### <4. Each of Embodiments>

Hereinafter, the formation of the test pattern will be described in detail for each embodiment. Note that, in each of the following embodiments, a mark for checking the presence or absence of misregistration between the primer and the colored ink and adjusting the register (hereinafter, this mark is referred to as a “register adjustment mark”) is formed on the print medium 12 as a test pattern.

### <4.1 First Embodiment>

### <4.1.1 Test Pattern>

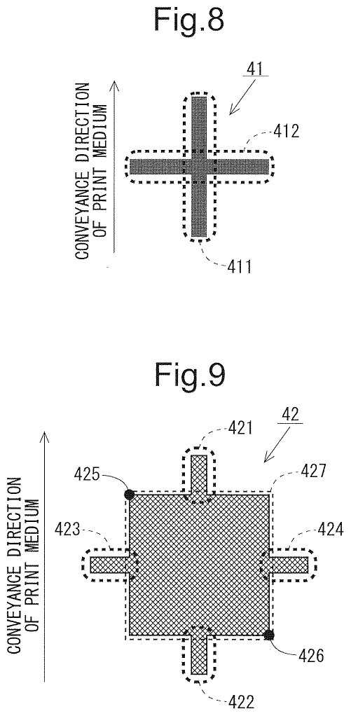

FIG. 7 is a diagram schematically illustrating a register adjustment mark 40 formed on the print medium 12 in the present embodiment. The register adjustment mark 40 is a mark obtained by combining a pattern 41 illustrated in FIG. 8 and a pattern 42 illustrated in FIG. 9. The pattern 41 is a pattern to be formed by a primer, and the pattern 42 is a pattern to be formed by one colored ink (for example, cyan ink). A region where the pattern 41 is to be formed on the print medium 12 is a first region, and a region where the pattern 42 is to be formed on the print medium 12 is a second region.

As illustrated in FIG. 8, the pattern 41 includes a first linear part 411 extending in the conveyance direction of the print medium 12 and a second linear part 412 extending in a direction orthogonal to the conveyance direction of the print medium 12. The first linear part 411 and the second linear part 412 have, for example, shapes intersecting each other at the central parts thereof. That is, the pattern 41 has a cross shape. When the region corresponding to the first linear part 411 and the region corresponding to the second linear part 412 with respect to the region on the print medium 12 are defined as a first linear region and a second linear region, respectively, the first region in the present embodiment includes a first linear region extending in the conveyance direction of the print medium 12 and a second linear region extending in a direction orthogonal to the conveyance direction of the print medium 12. The first linear region and the second linear region intersect so that the center position of the first linear region and the center position of the second linear region coincide with each other. The first linear part 411 is formed by ejecting a primer from a single nozzle 152 or a group of adjacent nozzles 152 (for example, 2 to 5 nozzles 152 adjacent to each other in the main scanning direction). The second linear part 412 is formed by ejecting a primer from a group of adjacent nozzles 152 (for example, a large number of nozzles 152 adjacent to each other in the main scanning direction).

As illustrated in FIG. 9, the pattern 42 has a shape including a smallest rectangular part 427 (rectangular part in which a vertex denoted by reference sign 425 is an upper left vertex and a vertex denoted by reference sign 426 is a lower right vertex) encompassing the pattern 41 and four protrusion parts (first to fourth protrusion parts 421 to 424). When regions corresponding to the first to fourth protrusion parts 421 to 424 with respect to the region on the print medium 12 are defined as first to fourth protrusion regions, respectively, as can be grasped from FIGS. 7 to 9, the second region in the present embodiment includes a smallest rectangular region encompassing the first linear region and the second linear region, a first protrusion region extending from one edge of the first linear region to a side opposite to the first linear region, a second protrusion region extending from the other edge of the first linear region to a side opposite to the first linear region, a third protrusion region extending from one edge of the second linear region to a side opposite to the second linear region, and a fourth protrusion region extending from the other edge of the second linear region to a side opposite to the second linear region. Hereinafter, the first linear region and the second linear region may be collectively referred to simply as a “linear region”. Note that the first protrusion part 421 and the second protrusion part 422 are formed by the same nozzles 152. In the present embodiment, the first protrusion part 421 and the second protrusion part 422 are formed by ejecting the colored ink from the same number of nozzles 152 as the number of nozzles 152 forming the first linear part 411.

The pattern 41 and the pattern 42 are formed such that the center line of the first linear part 411 in the main scanning direction coincides with the center lines of the first protrusion part 421 and the second protrusion part 422 in the main scanning direction in a state where there is no deviation in the main scanning direction between the primer ejection head 150(P) forming the pattern 41 and the colored ink ejection head 150 forming the pattern 42. Similarly, the pattern 41 and the pattern 42 are formed such that the center line of the second linear part 412 in the conveyance direction coincides with the center lines of the third protrusion part 423 and the fourth protrusion part 424 in the conveyance direction (conveyance direction of the print medium 12) in a state where there is no deviation in the conveyance direction between the primer ejection head 150(P) forming the pattern 41 and the colored ink ejection head 150 forming the pattern 42.

Since the pattern 42 has four protrusion parts (first to fourth protrusion parts 421 to 424) as illustrated in FIG. 9, it is possible to check the presence or absence of misregistration in the conveyance direction of the print medium 12 and the presence or absence of misregistration in the direction (main scanning direction) orthogonal to the conveyance direction of the print medium 12 between any colored ink ejection head 150 and the primer ejection head 150(P).

Each of the first protrusion part 421 and the second protrusion part 422 is formed at a position adjacent to the first linear part 411 in the conveyance direction of the print medium 12. Furthermore, the second region includes a region (rectangular part 427) extending in a direction (main scanning direction) orthogonal to the conveyance direction of the print medium 12 in a region overlapping with the first linear region (region corresponding to the first linear part 411). Under this situation, when the first linear part 411 is printed to be deviated in the direction orthogonal to the conveyance direction of the print medium 12, the first linear part 411 is printed at a position deviated in the same direction from the first protrusion part 421 and the second protrusion part 422. As a result, the positional deviation of the first linear part 411 in the direction orthogonal to the conveyance direction of the print medium 12 can be visually checked. That is, each of the first protrusion part 421 and the second protrusion part 422 is used as an index for checking the positional deviation of the first linear part 411.

Each of the third protrusion part 423 and the fourth protrusion part 424 is formed at a position adjacent to the second linear part 412 in the main scanning direction. Furthermore, the second region includes a region (rectangular part 427) extending in the conveyance direction of the print medium 12 in a region overlapping with the second linear region (region corresponding to the second linear part 412). Under this situation, when the second linear part 412 is printed to be deviated in the conveyance direction of the print medium 12, the second linear part 412 is printed at a position deviated in the same direction from the third protrusion part 423 and the fourth protrusion part 424. As a result, the positional deviation of the second linear part 412 in the conveyance direction of the print medium 12 can be visually checked. That is, each of the third protrusion part 423 and the fourth protrusion part 424 is used as an index for checking the positional deviation of the second linear part 412.

Note that the shape of the index for checking the positional deviation of the first linear part 411 or the second linear part 412 is not limited to a shape protruding from the outer edge of the second region (more specifically, the rectangular part 427) to the conveyance direction of the print medium 12 or a direction orthogonal to the conveyance direction of the print medium 12 (that is, the index is not limited to a protrusion part). The shape of the index may be, for example, a shape recessed from the outer edge of the second region to the conveyance direction of the print medium 12 or a direction orthogonal to the conveyance direction of the print medium 12 (that is, the index may be a concave part) (see FIG. 18 to be described later).

### <4.1.2 Formation of Test Pattern>

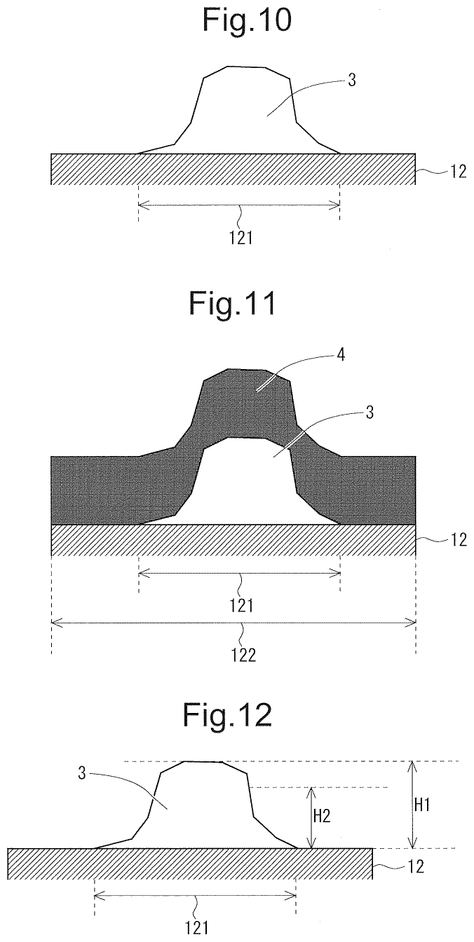

In the process of forming the test pattern on the print medium 12, in step S10 of FIG. 6, the primer 3 is ejected to the first region 121 on the print medium 12 as illustrated in FIG. 10. After the primer 3 is cured, the colored ink 4 is ejected onto the second region 122 on the print medium 12 as illustrated in FIG. 11 (step S30 of FIG. 6). At this time, as can be grasped from FIG. 11, the colored ink 4 is ejected onto the primer 3 in the first region 121, and the colored ink 4 is directly ejected onto the print medium 12 in the peripheral region of the first region 121 (the peripheral region of the first region 121 is, in other words, a region obtained by excluding the first region 121 from the second region 122).

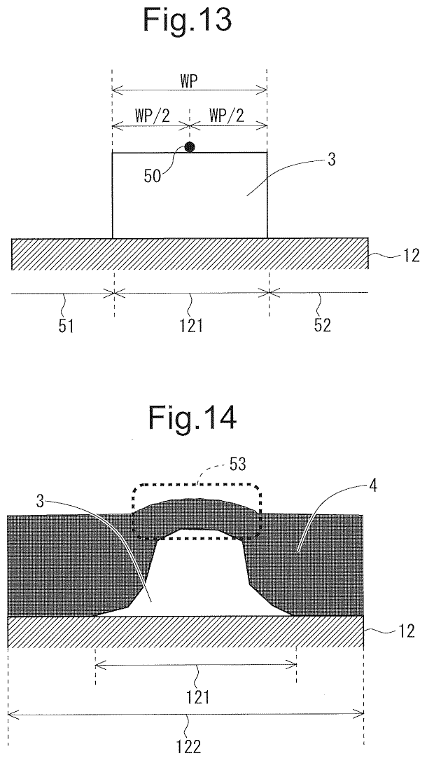

In step S30 of FIG. 6, the colored ink 4 is ejected from the colored ink ejection head so that the liquid level height H2 of the colored ink 4 in the peripheral region of the first region 121 is greater than or equal to 70% of the liquid level height H1 of the primer 3 in the first region 121 (see FIG. 12). Furthermore, when the ratio of the amount of colored ink actually ejected onto the print medium 12 to the amount of colored ink required to form a solid pattern on the print medium 12 is defined as a printing rate, the colored ink 4 is ejected from the colored ink ejection head so that the printing rate is 70% or more and 200% or less. Moreover, when the width of the region where the primer 3 is ejected (the width of the above-described linear region) is expressed by WP, in the present embodiment, the flow distance of the colored ink 4 ejected to the first region 121 in step S30 of FIG. 6 (that is, the flow distance of the colored ink 4 ejected on the primer 3) is longer than (WP/2). In other words, the width of the linear region is set such that the colored ink 4 ejected at the center of the linear region in the width direction flows to the region outside the linear region. That is, the width of the linear region is set so that the colored ink 4 ejected at the position denoted by reference sign 50 in FIG. 13 flows to the region denoted by reference sign 51 or the region denoted by reference sign 52. Note that, in FIG. 13, for convenience, the primer 3 on the print medium 12 is represented by a rectangle. Hereinafter, the primer 3 and the colored ink 4 on the print medium 12 may be represented by rectangles in other drawings.

With such a configuration, the colored ink 4 ejected onto the primer 3 is less likely to stay on the primer 3. Therefore, a large amount of the colored ink 4 on the primer 3 flows to the peripheral region of the first region 121, and the layer of the colored ink 4 becomes thinner on the primer 3 than other regions. That is, the state of the colored ink 4 on the print medium 12 changes from the state as illustrated in FIG. 11 to the state as illustrated in FIG. 14 until the colored ink 4 is cured in step S40 of FIG. 6 after the colored ink 4 is ejected in step S30 of FIG. 6. The layer of the colored ink 4 is thinner in a portion denoted by reference sign 53 in FIG. 14 than in the other portions.

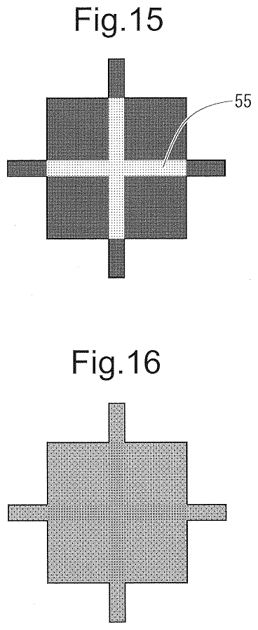

As described above, the layer of the colored ink 4 becomes thinner on the primer 3 than the other regions. As a result, the print image of the test pattern appearing on the print medium 12 is schematically as illustrated in FIG. 15. A region denoted by reference sign 55 in FIG. 15 corresponds to the first region 121, and the color of the colored ink 4 becomes lighter in this region than in other regions. In this way, it is possible to visually check the region to which the primer 3 is applied.

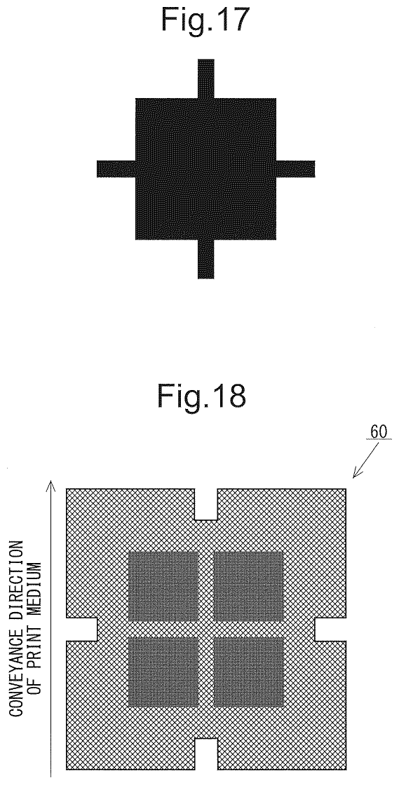

Note that the printing rate of the colored ink 4 is 70% or more and 200% or less in the present embodiment, but when the printing rate is too low, the print image of the test pattern is schematically as illustrated in, for example, FIG. 16, and when the printing rate is too high, the print image of the test pattern is schematically as illustrated in, for example, FIG. 17. In the examples illustrated in FIGS. 16 and 17, it is difficult to visually check the region to which the primer 3 is applied.

### <4.1.3 Effects>

According to the present embodiment, when the test pattern (register adjustment mark 40) for inspecting the ejection state of the primer 3 is formed on the print medium 12, after the primer 3 ejected from the primer ejection head 150(P) is cured, the colored ink 4 is ejected from the colored ink ejection head toward the region to which the primer 3 is applied and the peripheral region thereof so that the height of the liquid level of the colored ink 4 in the peripheral region of the region to which the primer 3 is applied is 70% or more of the height of the liquid level of the primer 3 and the printing rate of the colored ink 4 is 70% or more and 200% or less. Here, the width of the linear region is set such that the flow distance of the colored ink 4 ejected onto the primer 3 is longer than ½ times the width of the linear region to which the primer 3 is to be applied. Thus, the colored ink 4 is less likely to stay on the primer 3, and the colored ink 4 on the primer 3 flows to the periphery, and the layer of the colored ink 4 becomes thinner in the region where the primer 3 is applied than in other regions (the density of the colored ink 4 becomes lower in the region where the primer 3 is applied). This makes it possible to visually check the region to which the primer 3 is applied. As above, according to the present embodiment, it is possible to easily check the application state of the primer on the print medium 12 (ejection state of the primer from the print head 150) in the inkjet printing apparatus 10. Furthermore, since occurrence the of the misregistration at the time of main printing is suppressed by performing the inspection in advance, wasteful consumption of the print medium 12 and the ink is suppressed. In this way, it is possible to contribute to the achievement of the SDGs (sustainable development goals).

### <4.2 Second Embodiment>

### <4.2.1 Test Pattern>

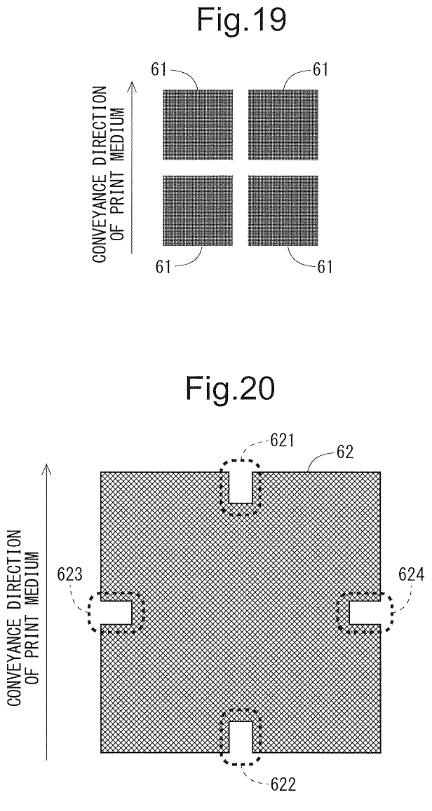

FIG. 18 is a diagram schematically illustrating a register adjustment mark 60 formed on the print medium 12 in the present embodiment. The register adjustment mark 60 is a mark obtained by combining four patterns 61 illustrated in FIG. 19 and a pattern 62 illustrated in FIG. 20. The four patterns 61 are patterns to be formed by the primer, and the pattern 62 is a pattern to be formed by one colored ink (for example, cyan ink). In the present embodiment, a region corresponding to each of the four patterns 61 is a first region, and a region corresponding to the pattern 62 is a second region.

Each of the four patterns 61 illustrated in FIG. 19 has a rectangular shape. By disposing the four patterns 61 as illustrated in FIG. 19, a cross-shaped region where no primer is ejected is formed. Note that, hereinafter, regarding each pattern 61, the width in the conveyance direction of the print medium 12 is referred to as “first width”, and the width in the direction orthogonal to the conveyance direction of the print medium 12 is referred to as “second width”. As illustrated in FIG. 20, the pattern 62 has a substantially rectangular shape including four concave parts 621 to 624.

Each of the patterns 61 is formed by ejecting a primer from a group of a plurality of nozzles 152 adjacent in the main scanning direction. The pattern 62 is formed by ejecting a colored ink from a group of the plurality of nozzles 152. The patterns 61 and the pattern 62 are formed such that the center line, in the main scanning direction, of the cross-shaped region in which the primer is not ejected among the regions encompassing the four patterns 61 coincides with the center line of the concave part 621 and the concave part 622 in the main scanning direction in a state in which there is no deviation in the main scanning direction between the primer ejection head 150(P) forming the patterns 61 and the colored ink ejection head 150 forming the pattern 62. Similarly, the patterns 61 and the pattern 62 are formed such that the center line, in the conveyance direction (conveyance direction of the print medium 12), of the cross-shaped region in which the primer is not ejected among the regions encompassing the four patterns 61 coincides with the center line of the concave part 623 and the concave part 624 in the conveyance direction in a state in which there is no deviation in the conveyance direction between the primer ejection head 150(P) forming the patterns 61 and the colored ink ejection head 150 forming the pattern 62.

By using the above mark obtained by combining the pattern 62 including the four concave parts 621 to 624 and the four patterns 61 each having a rectangular shape as the register adjustment mark 60, it is possible to check the presence or absence of misregistration in the conveyance direction of the print medium 12 between any colored ink ejection head 150 and the primer ejection head 150(P) and the presence or absence of misregistration in the direction (main scanning direction) orthogonal to the conveyance direction of the print medium 12.

### <4.2.2 Formation of Test Pattern>

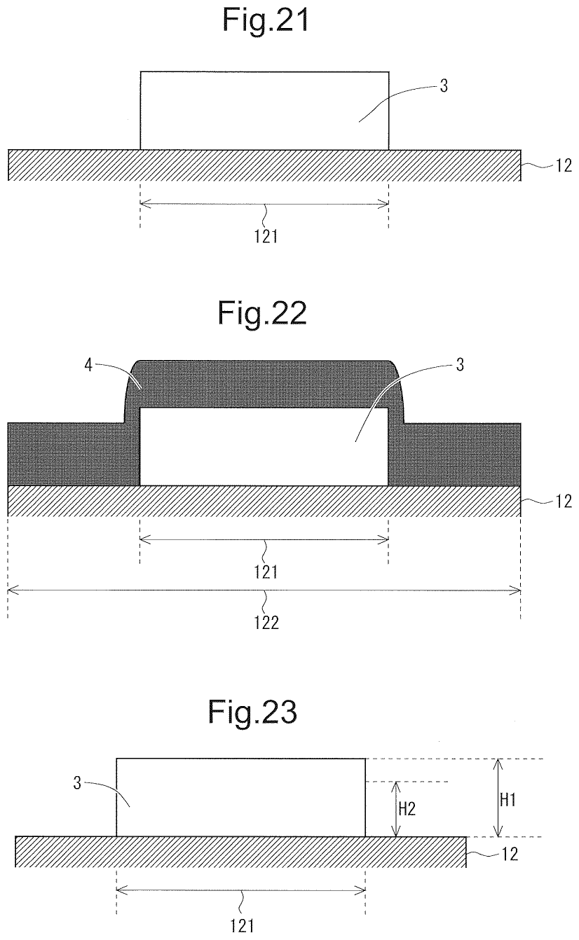

In the process of forming the test pattern on the print medium 12, in step S10 of FIG. 6, the primer 3 is ejected toward the first region 121 on the print medium 12 as illustrated in FIG. 21. After the primer 3 is cured, the colored ink 4 is ejected toward the second region 122 on the print medium 12 as illustrated in FIG. 22 (step S30 of FIG. 6). At this time, as can be grasped from FIG. 22, the colored ink 4 is ejected onto the primer 3 in the first region 121, and the colored ink 4 is directly ejected onto the print medium 12 in the peripheral region of the first region 121.

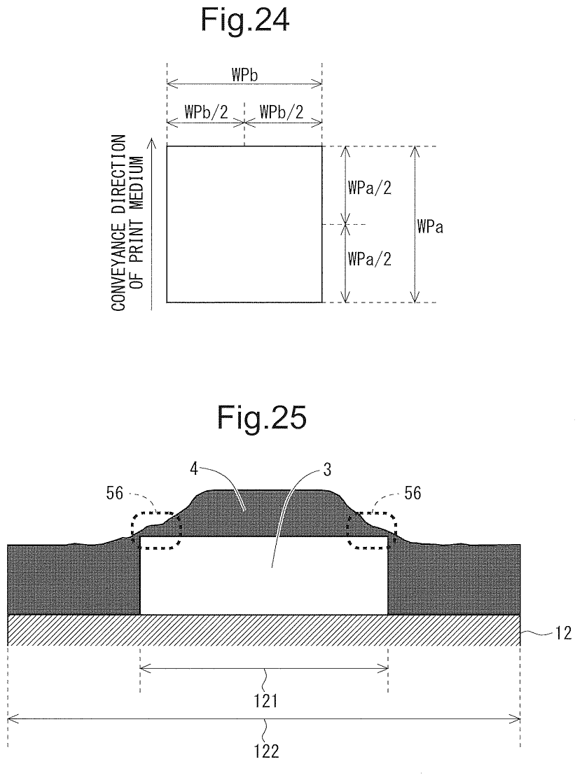

In step S30 of FIG. 6, as in the first embodiment, the colored ink 4 is ejected from the colored ink ejection head so that the liquid level height H2 of the colored ink 4 in the peripheral region of the first region 121 is 70% or more of the liquid level height H1 of the primer 3 in the first region 121 (see FIG. 23). Furthermore, as in the first embodiment, the colored ink 4 is ejected from the colored ink ejection head so that the printing rate is 70% or more and 200% or less. Moreover, regarding the region where the primer 3 is ejected (that is, the region corresponding to the pattern 61), when the above-described first width is represented by WPa and the above-described second width is represented by WPb, in the present embodiment, the flow distance of the colored ink 4 ejected to the first region 121 in step S30 of FIG. 6 (that is, the flow distance of the colored ink 4 ejected on the primer 3) is shorter than (WPa/2) and shorter than (WPb/2) (see FIG. 24). In other words, the size of the first region 121 is set so that the colored ink 4 ejected at the center of the first region 121 does not reach any portion of the four sides of the first region 121 by the flow.

According to the above configuration, the colored ink 4 ejected at the edge of the first region 121 flows to the peripheral region of the first region 121, but the colored ink 4 ejected at the center of the first region 121 remains on the primer 3. As a result, the state of the colored ink 4 on the print medium 12 changes from the state as illustrated in FIG. 22 to the state as illustrated in FIG. 25 until the colored ink 4 is cured in step S40 of FIG. 6 after the colored ink 4 is ejected in step $30 of FIG. 6. The layer of the colored ink 4 is thinner in a portion denoted by reference sign 56 in FIG. 25 (that is, in the edge of the first region 121) than in other portions.

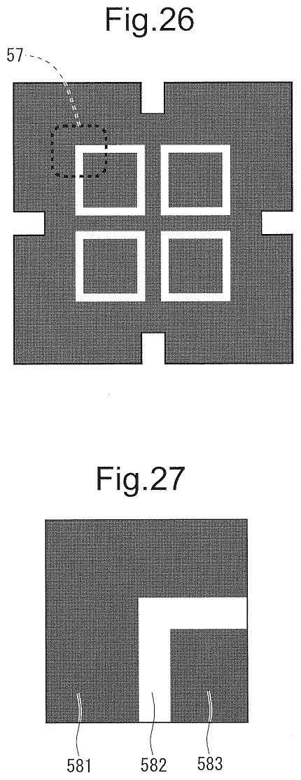

As described above, since the layer of the colored ink 4 is thinner in the edge of the first region 121 than in other regions, the print image of the test pattern appearing on the print medium 12 is schematically as illustrated in FIG. 26. FIG. 27 is an enlarged view of a portion denoted by reference sign 57 in FIG. 26. In FIG. 27, a region denoted by reference sign 581 corresponds to a peripheral region of the first region 121, a region denoted by reference sign 582 corresponds to an edge region of the first region 121, and a region denoted by reference sign 583 corresponds to a region other than the edge region in the first region 121. As illustrated in FIG. 27, the color of the colored ink 4 becomes lighter in the edge region of the first region 121 than in the other regions. In this manner, it is possible to visually check the position of the edge (contour) of the region to which the primer 3 is applied.

### <4.2.3 Effects>

According to the present embodiment, when the test pattern (register adjustment mark 60) for inspecting the ejection state of the primer 3 is formed on the print medium 12, after the primer 3 ejected from the primer ejection head 150(P) is cured, the colored ink 4 is ejected from the colored ink ejection head toward the region to which the primer 3 is applied and the peripheral region thereof so that the height of the liquid level of the colored ink 4 in the peripheral region of the region to which the primer 3 is applied is 70% or more of the height of the liquid level of the primer 3 and the printing rate of the colored ink 4 is 70% or more and 200% or less. Here, the width (the first width and the second width) of the pattern 61 is set such that the flow distance of the colored ink 4 ejected onto the primer 3 is shorter than ½ times the first width of the rectangular pattern 61 constituting the register adjustment mark 60 and is shorter than ½ times the second width of the pattern 61. Thus, the colored ink 4 ejected to the edge of the region to which the primer 3 is applied flows to the periphery, but the colored ink 4 ejected to the vicinity of the center of the region to which the primer 3 is applied remains on the primer 3. As a result, the layer of the colored ink 4 becomes thinner in the edge region of the region where the primer 3 is applied than in other regions (the density of the colored ink 4 becomes lower in the edge region of the region where the primer 3 is applied). This makes it possible to visually check the region to which the primer 3 is applied. As above, according to the present embodiment, as in the first embodiment, it is possible to easily check the application state of the primer on the print medium 12 (the ejection state of the primer from the print head 150) in the inkjet printing apparatus 10.

### <4.3 Third Embodiment>

### <4.3.1 Test Pattern>

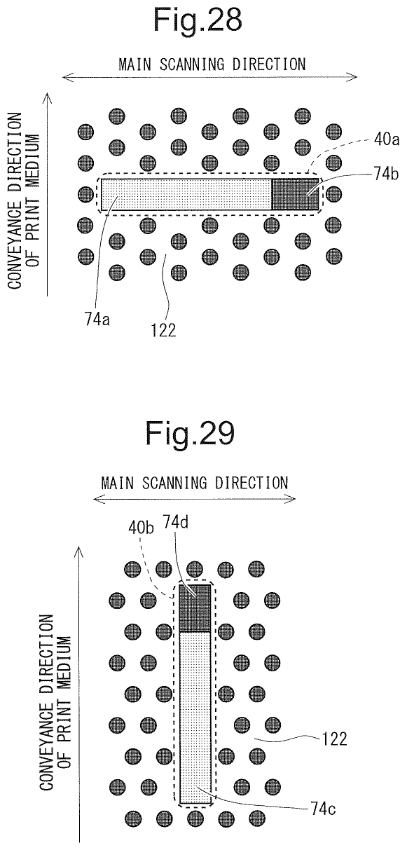

As the register adjustment mark 40 formed on the print medium 12 in the present embodiment, two examples of a first register adjustment pattern 40a illustrated in FIG. 28 and a second register adjustment pattern 40b illustrated in FIG. 29 are exemplified. The first register adjustment pattern 40a includes a first FIG. 74a formed by ejecting the primer 3 onto the first region 121 on the print medium 12 and a first index 74b formed by ejecting the colored ink 4 onto the print medium 12. The second registration adjustment pattern 40b includes a second FIG. 74c formed by ejecting the primer 3 onto the first region 121 on the print medium 12 and a second index 74d formed by ejecting the colored ink 4 onto the print medium 12. Each of the region of the first FIG. 74a and its peripheral region (excluding the region of the first index 74b) is included in the second region 122 formed with the colored ink 4 having a low printing rate.

Each of the region of the second FIG. 74c and its peripheral region (excluding the region of the second index 74d) is included in the second region 122 formed with the colored ink 4 having a low printing rate. Details will be described later.

### <4.3.2 Formation of Test Pattern>

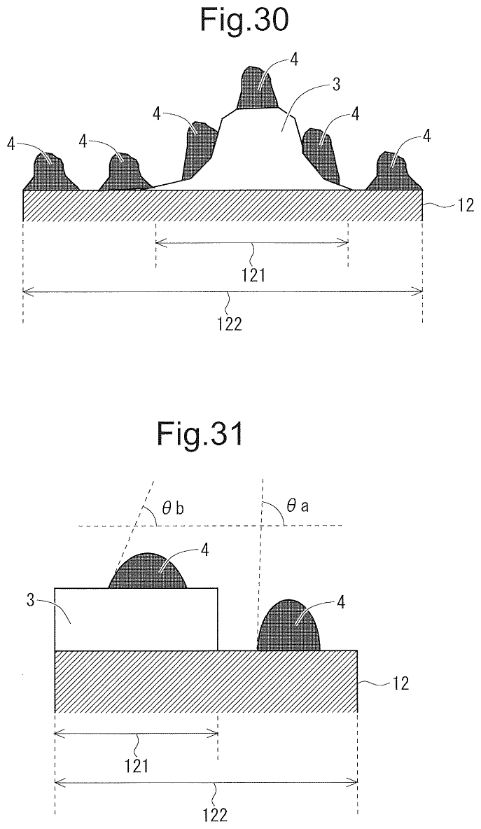

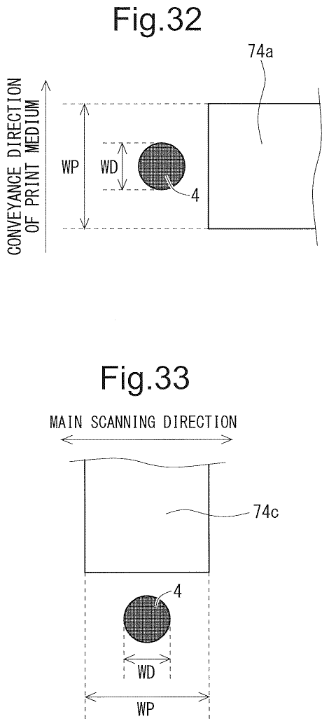

In the present embodiment, unlike the first embodiment, in step S30 of FIG. 6, the colored ink 4 is ejected from the colored ink ejection head toward the second region 122 so that the printing rate is 5% or more and 30% or less. Therefore, the colored ink 4 is printed with discrete dots. Due to this, immediately after the ejection of the colored ink 4, the state of the colored ink 4 on the print medium 12 is as illustrated in FIG. 30. At this time, as illustrated in FIG. 31, the contact angle θa of the colored ink 4 on the print medium 12 in the peripheral region of the first region 121 is larger than the contact angle θb of the colored ink 4 on the primer 3 in the first region 121. Furthermore, the dot diameter of the colored ink 4 on the print medium 12 in the peripheral region of the first region 121 is smaller than the width of the above-described linear region constituting the first region 121. In other words, the width of each of the first FIG. 74a and the second FIG. 74c constituting the first region 121 is set to be larger than the dot diameter of the colored ink 4 on the print medium 12. In this regard, for example, focusing on the vicinity of each of the first FIG. 74a and the second FIG. 74c, as illustrated in FIGS. 32 and 33, a dot diameter WD of the colored ink 4 in the peripheral region of the first region 121 is smaller than a width WP of each of the first FIG. 74a and the second FIG. 74c.

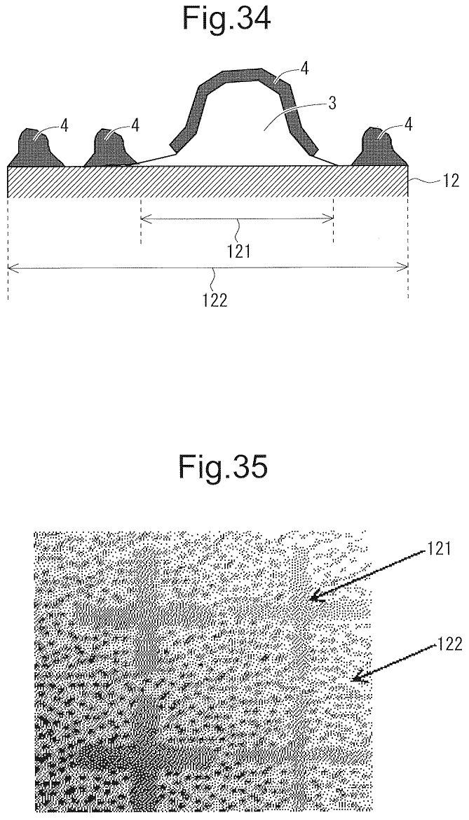

With such a configuration, the colored ink 4 wets and spreads in the first region 121 (that is, on the primer 3), whereas the colored ink 4 cures without almost spreading in the peripheral region of the first region 121. Thus, the state of the colored ink 4 on the print medium 12 changes from the state as illustrated in FIG. 30 to the state as illustrated in FIG. 34 until the colored ink 4 is cured in step S40 of FIG. 6 after the colored ink 4 is ejected in step S30 of FIG. 6. As can be seen from FIG. 34, the dots of the colored ink 4 are discretely present in the peripheral region of the first region 121, whereas the colored ink 4 spreads thinly in the first region 121. Therefore, the print image of the test pattern appearing on the print medium 12 is schematically as illustrated in FIG. 28 or 29. A region denoted by reference sign 74a in FIG. 28 and a region denoted by reference sign 74c in FIG. 29 correspond to the first region 121, and these regions look darker than the second region 122 (regarding FIG. 28, a region obtained by removing a region denoted by reference sign 74b from a region other than the first region 121, and regarding FIG. 29, a region obtained by removing a region denoted by reference sign 74d from a region other than the first region 121) formed of the colored ink 4 having a low printing rate. This is because the entire upper surface of the print medium 12 is thinly and widely covered with the colored ink 4 in the first region 121, whereas a region having an area of half or more of the upper surface of the print medium 12 is not covered with the colored ink 4 in the second region 122. An experimental result is illustrated in FIG. 35. FIG. 35 is a diagram illustrating a result of an experimental example in which the primer 3 was applied to the first region 121 and then the colored ink 4 was applied to the upper surface of the print medium 12 at a printing rate of 20%. As illustrated in FIG. 35, the entire upper surface of the print medium 12 is thinly and widely covered with the colored ink 4 in the first region 121 indicated by the cross mark, whereas a region having an area of half or more of the upper surface of the print medium 12 is not covered with the colored ink 4 in the second region 122 around the first region 121. As a result, it is possible to visually distinguish the region to which the primer 3 is applied and the region to which the primer 3 is not applied.

Moreover, in a case where the first register adjustment pattern 40a illustrated in FIG. 28 is adopted, in step S30 of FIG. 6, the colored ink 4 is ejected from the colored ink ejection head 150 to a position adjacent to the first FIG. 74a in the main scanning direction to form the first index 74b. The printing rate of the colored ink 4 when forming the first index 74b may be any printing rate, but the printing rate is desirably 30% or more. Furthermore, in a case where the second register adjustment pattern 40b illustrated in FIG. 29 is adopted, in step S30 of FIG. 6, the colored ink 4 is ejected from the colored ink ejection head 150 to a position adjacent to the second FIG. 74c in the conveyance direction of the print medium 12 to form the second index 74d. The printing rate of the colored ink 4 when forming the second index 74d may be any printing rate, but the printing rate is desirably 30% or more.

In the case of adopting the first register adjustment pattern 40a illustrated in FIG. 28, when the ejecting position of the primer 3 and the ejecting position of the colored ink 4 are correctly positioned in the conveyance direction of the print medium 12, as illustrated in FIG. 28, the first FIG. 74a and the first index 74b are formed at the same position in the conveyance direction of the print medium 12. However, when a deviation occurs between the ejecting position of the primer 3 and the ejecting position of the colored ink 4 in the conveyance direction of the print medium 12, a positional deviation in the conveyance direction of the print medium 12 occurs between the forming position of the first FIG. 74a and the forming position of the first index 74b. Thus, it is possible to check the presence or absence and degree of positional deviation in the conveyance direction of the print medium 12 between the ejecting position of the primer 3 and the ejecting position of the colored ink 4.

In the case of adopting the second register adjustment pattern 40b illustrated in FIG. 29, when the ejecting position of the primer 3 and the ejecting position of the colored ink 4 are correctly positioned in the main scanning direction, as illustrated in FIG. 29, the second FIG. 74c and the second index 74d are formed at the same position in the main scanning direction. However, when a deviation occurs between the ejecting position of the primer 3 and the ejecting position of the colored ink 4 in the main scanning direction, a positional deviation in the main scanning direction occurs between the forming position of the second FIG. 74c and the forming position of the second index 74d. Thus, it is possible to check the presence or absence and degree of positional deviation in the main scanning direction between the ejecting position of the primer 3 and the ejecting position of the colored ink 4.

### <4.3.3 Effects>

According to the present embodiment, when a test pattern (register adjustment mark: the first register adjustment pattern 40a and the second register adjustment pattern 40b) for inspecting the ejection state of the primer 3 is formed on the print medium 12, after the primer 3 ejected from the primer ejection head 150(P) is cured, the colored ink 4 is ejected from the colored ink ejection head toward the region to which the primer 3 is applied and its peripheral region so that the printing rate of the colored ink 4 is 5% or more and 30% or less. Here, the contact angle of the colored ink 4 on the print medium 12 in the peripheral region of the region applied with the primer 3 is larger than the contact angle of the colored ink 4 on the primer 3. Furthermore, the dot diameter of the colored ink 4 on the print medium in the peripheral region of the region to which the primer 3 is applied is smaller than the width of the linear region to which the primer 3 is to be applied. From the above, the colored ink 4 cures without almost spreading in the peripheral region of the region to which the primer 3 is applied, whereas the colored ink 4 wets and spreads in the region to which the primer 3 is applied, so the region to which the primer 3 is applied looks darker than the other regions. This makes it possible to visually check the region to which the primer 3 is applied. As above, according to the present embodiment, as in the first embodiment, it is possible to easily check the application state of the primer on the print medium 12 (the ejection state of the primer from the print head 150) in the inkjet printing apparatus 10.

### <4.4 Fourth Embodiment>

### <4.4.1 Test Pattern>

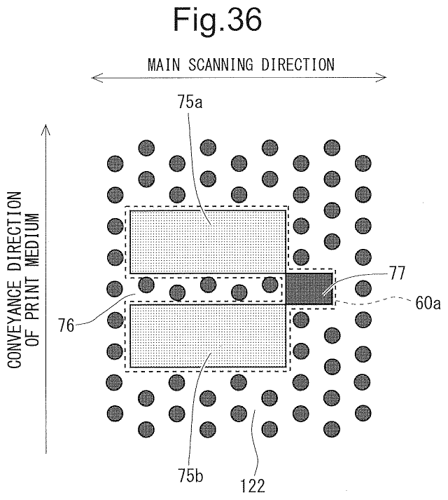

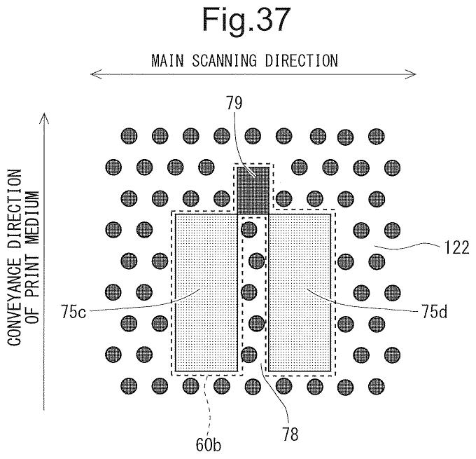

As a register adjustment mark 60 formed on the print medium 12 in the present embodiment, two examples of a first register adjustment pattern 60a illustrated in FIG. 36 and a second register adjustment pattern 60b illustrated in FIG. 37 are exemplified. Details will be described later.

### <4.4.2 Formation of Test Pattern>

In the present embodiment, unlike the first and second embodiments, in step S30 of FIG. 6, the colored ink 4 is ejected from the colored ink ejection head so that the printing rate is 5% or more and 30% or less. In other words, the same printing rate as that of the third embodiment is adopted. As in the third embodiment, the contact angle θa of the colored ink 4 on the print medium 12 in the peripheral region of the first region 121 is larger than the contact angle θb of the colored ink 4 on the primer 3 in the first region 121.

The first register adjustment pattern 60a illustrated in FIG. 36 includes a first FIG. 75a and a second FIG. 75b formed by ejecting the primer 3 to the first region 121 on the print medium 12. The first FIG. 75a and the second FIG. 75b are juxtaposed in the conveyance direction of the print medium 12. The colored ink 4 is ejected at a printing rate of 5% or more and 30% or less to the second region 122 including the first region 121 (the regions of the first FIG. 75a and the second FIG. 75b) and its peripheral region (excluding the region of the index 77). The second region 122 located between the first FIG. 75a and the second FIG. 75b is defined as a “gap region”. The gap region is denoted by reference sign 76. The first register adjustment pattern 60a further includes the index 77 formed of the colored ink 4 of any printing rate (however, the printing rate is preferably 30% or more). The index 77 is formed at a position adjacent to the gap region 76 in the main scanning direction (direction orthogonal to the conveyance direction of the print medium 12).

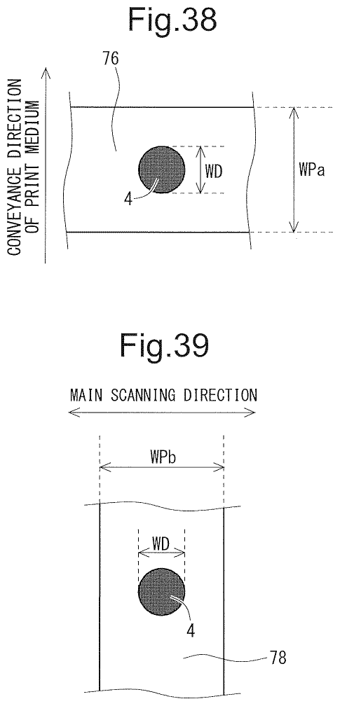

FIG. 38 is a partially enlarged view of the gap region 76. As illustrated in FIG. 38, a dot diameter WD of the colored ink 4 on the print medium 12 in the gap region 76 (peripheral region of the first region 121) is smaller than a first width (width of the gap region 76 with respect to the conveyance direction of the print medium 12) WPa. In other words, the first width WPa is set to a width larger than the dot diameter WD of the colored ink 4 on the print medium 12.

With such a configuration, as in the third embodiment, the colored ink 4 wets and spreads in the first region 121 (that is, on primer 3), whereas the colored ink 4 cures without almost spreading in the peripheral region of the first region 121. As a result, the print image of the first register adjustment pattern 60a appearing on the print medium 12 is schematically as illustrated in FIG. 36. A region corresponding to each of the first FIG. 75a and the second FIG. 75b in FIG. 36 corresponds to the first region 121, and the region looks darker than other regions. In this manner, it is possible to visually distinguish the region to which the primer 3 is applied and the region to which the primer 3 is not applied.

In a case where the primer 3 is ejected to a correct position in the conveyance direction of the print medium 12, the position of the gap region 76 and the position of the index 77 coincide with each other in the conveyance direction of the print medium 12. When the ejecting position of the primer 3 deviates from the correct position in the conveyance direction of the print medium 12, the position of the first FIG. 75a or the second FIG. 75b shifts toward the gap region 76, and the density of the gap region 76 increases. As a result, it becomes possible to visually check that the position of the gap region 76 and the position of the index 77 are relatively deviated in the conveyance direction of the print medium 12.

The second register adjustment pattern 60b illustrated in FIG. 37 includes a third FIG. 75c and a fourth FIG. 75d formed by ejecting the primer 3 to the first region 121 on the print medium 12. The third FIG. 75c and the fourth FIG. 75d are juxtaposed in a direction (main scanning direction) orthogonal to the conveyance direction of the print medium 12. The colored ink 4 is ejected at a printing rate of 5% or more and 30% or less to the second region 122 including the first region 121 (the regions of the third FIG. 75c and the fourth FIG. 75d) and its peripheral region (excluding the region of an index 79). Here, the second region 122 located between the third FIG. 75c and the fourth FIG. 75d is defined as a “gap region”. The gap region is denoted by reference sign 78. The second register adjustment pattern 60b further includes the index 79 formed of the colored ink 4 of any printing rate (however, the printing rate is preferably 30% or more). The index 79 is formed at a position adjacent to the gap region 78 in the conveyance direction of the print medium 12.

FIG. 39 is a partially enlarged view of the gap region 78. As illustrated in FIG. 39, a dot diameter WD of the colored ink 4 on the print medium 12 in the gap region 78 (peripheral region of the first region 121) is smaller than a second width (width of the gap region 78 with respect to the main scanning direction) WPb. In other words, the second width WPb is set to a width larger than the dot diameter WD of the colored ink 4 on the print medium 12.

With such a configuration, as in the third embodiment, the colored ink 4 wets and spreads in the first region 121 (that is, on primer 3), whereas the colored ink 4 cures without almost spreading in the peripheral region of the first region 121. As a result, the print image of the second register adjustment pattern 60b appearing on the print medium 12 is schematically as illustrated in FIG. 37. A region corresponding to each of the third FIG. 75c and the fourth FIG. 75d in FIG. 37 corresponds to the first region 121, and the region looks darker than other regions. In this manner, it is possible to visually distinguish the region to which the primer 3 is applied and the region to which the primer 3 is not applied.

In a case where the primer 3 is ejected to a correct position in the direction (main scanning direction) orthogonal to the conveyance direction of the print medium 12, the position of the gap region 78 and the position of the index 79 coincide with each other in the main scanning direction. When the ejecting position of the primer 3 deviates from the correct position in the main scanning direction, the position of the third FIG. 75c or the fourth FIG. 75d shifts toward the gap region 78, and the density of the gap region 78 increases. As a result, it becomes possible to visually check that the position of the gap region 78 and the position of the index 79 are relatively deviated in the main scanning direction.

Note that, although the first FIG. 75a to the fourth FIG. 75d are represented by rectangles in FIGS. 36 and 37, these shapes are not limited to rectangles.

### <4.4.3 Effects>

According to the present embodiment, as in the third embodiment, the colored ink 4 cures without almost spreading in the peripheral region of the region to which the primer 3 is applied, whereas the colored ink 4 wets and spreads in the region to which the primer 3 is applied, so the region to which the primer 3 is applied looks darker than the other regions. This makes it possible to visually check the region to which the primer 3 is applied. As above, it is possible to easily check the application state of the primer on the print medium 12 (the ejection state of the primer from the print head 150) in the inkjet printing apparatus 10.

### <5. Modifications>

Hereinafter, modifications of the above embodiments will be described.

### <5.1 First Modification>

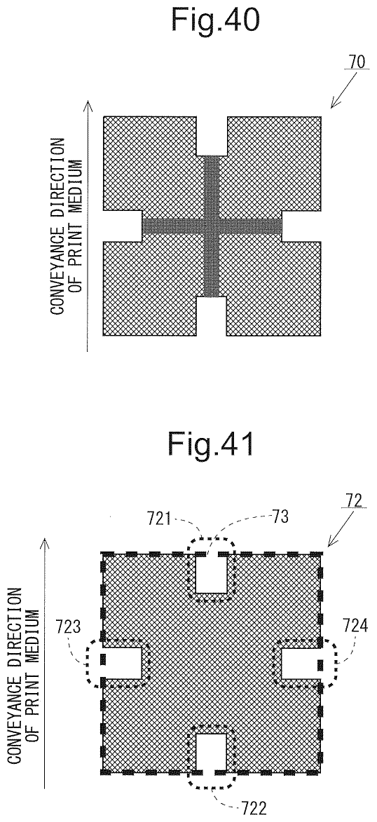

In the first embodiment, the register adjustment mark 40 illustrated in FIG. 7 is adopted. On the other hand, in the present modification, a register adjustment mark 70 as illustrated in FIG. 40 is adopted. The register adjustment mark illustrated in FIG. 40 is a mark obtained by combining the pattern 41 illustrated in FIG. 8 and a pattern 72 illustrated in FIG. 41.

When, with respect to the region on the print medium 12, the regions corresponding to the portions denoted by reference sign 721 to 724 in FIG. 41 are defined as the first to fourth predetermined regions, respectively, and the region corresponding to the first linear part 411 and the region corresponding to the second linear part 412 are defined as the first linear region and the second linear region, respectively (see FIG. 8), the second region in the present modification is a region obtained by excluding a first predetermined region extending from one edge of the first linear region to the opposite side of the first linear region, a second predetermined region extending from the other edge of the first linear region to the opposite side of the first linear region, a third predetermined region extending from one edge of the second linear region to the opposite side of the second linear region, and a fourth predetermined region extending from the other edge of the second linear region to the opposite side of the second linear region from a rectangular region (region corresponding to a rectangular portion denoted by reference sign 73 in FIG. 41) wider than a smallest rectangular region encompasing the first linear region and the second linear region.

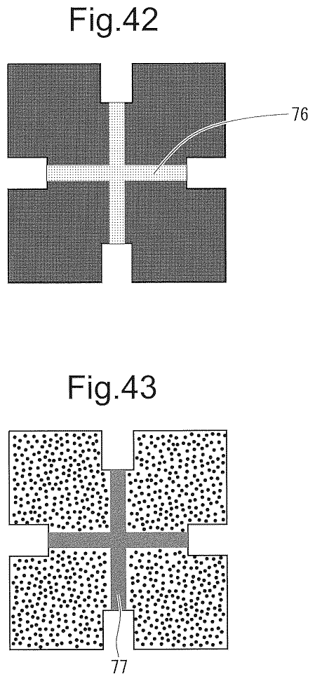

In a case where the printing rate of the colored ink 4 is set to 70 to 200% and the test pattern (register adjustment mark 70) is formed on the print medium 12 in the same manner as in the first embodiment, the print image of the test pattern appearing on the print medium 12 is schematically as illustrated in FIG. 42 in the present modification. A region denoted by reference sign 76 in FIG. 42 corresponds to the first region 121, and the layer of the colored ink 4 becomes thinner in the region than in other regions (the density of the colored ink 4 becomes lower in the region denoted by reference sign 76). Furthermore, in a case where the printing rate of the colored ink 4 is set to 10 to 30% and the test pattern is formed on the print medium 12 in the same manner as in the third embodiment, the print image of the test pattern appearing on the print medium 12 is schematically as illustrated in FIG. 43 in the present modification. A region denoted by reference sign 77 in FIG. 43 corresponds to the first region 121, and the region looks darker than other regions. As above, also in the present modification, it is possible to easily check the application state of the primer on the print medium 12 (ejection state of the primer from the print head 150) in the inkjet printing apparatus 10.

### <5.2 Second Modification>

In each of the above embodiments, an example in which a register adjustment mark is printed as a test pattern has been described. However, the present invention is not limited thereto. Therefore, an example in which a pattern used for detecting an ejection defect nozzle (hereinafter, this pattern is referred to as an “ejection defect nozzle detection pattern”) is printed as a test pattern will be described below as a second modification.

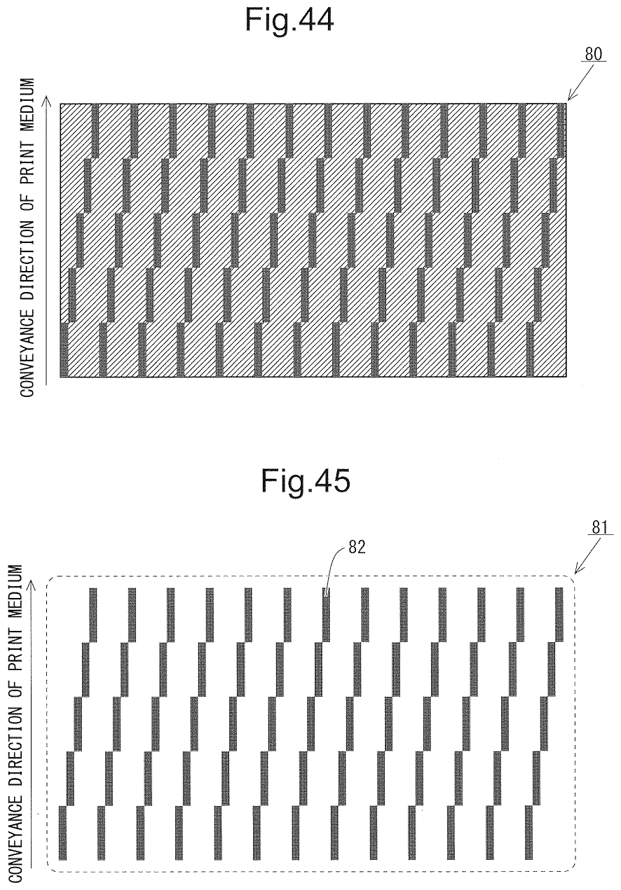

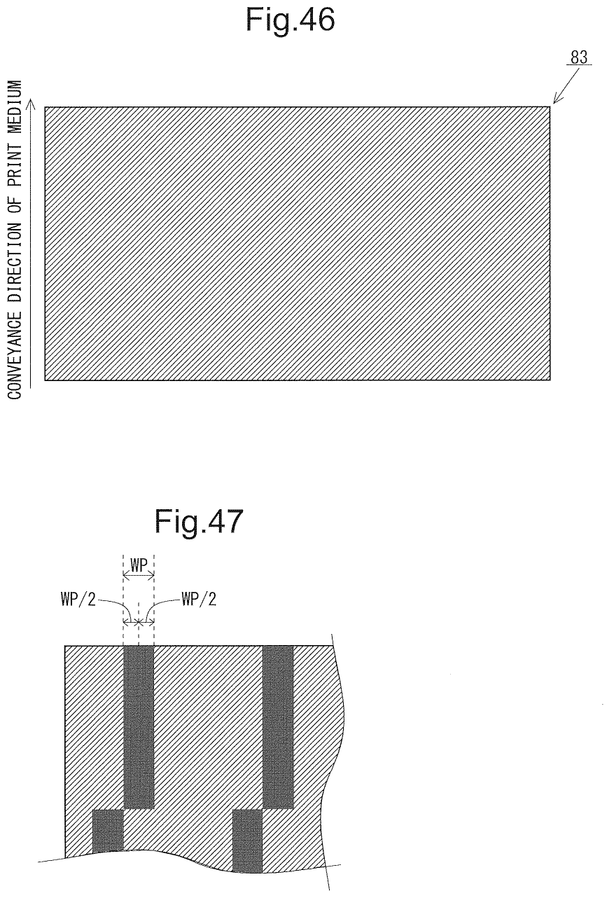

FIG. 44 is a diagram schematically illustrating an ejection defect nozzle detection pattern 80 formed on the print medium 12 in the present modification. The ejection defect nozzle detection pattern 80 is a pattern obtained by combining a pattern 81 illustrated in FIG. 45 and a pattern 83 illustrated in FIG. 46. The pattern 81 is a stepwise pattern including a large number of linear patterns 82 forming the first region 121. The pattern 83 has a rectangular shape forming the second region 122. In the present modification, a region where each linear pattern 82 is to be formed on the print medium 12 corresponds to the first linear region.

In the present modification, in step S10 of FIG. 6, the primer 3 is ejected from the primer ejection head 150(P) toward a plurality of first linear regions (regions where a plurality of the linear patterns 82 is to be formed) so that a stepwise pattern (see FIG. 45) is formed on the print medium 12 by the primer 3. The plurality of linear patterns 82 are formed by ejecting the primer 3 onto the print medium 12 from each of the plurality of nozzles 152 arranged in a direction orthogonal to the conveyance direction of the print medium 12 in the primer ejection head 150(P). The plurality of linear patterns 82 are formed so as to be separated from each other in the direction orthogonal to the conveyance direction of the print medium 12. Note that the form of the combination of the plurality of linear patterns 82 is not limited to the stepwise shape.

In a case where the printing rate of the colored ink 4 is set to 70 to 200%, the colored ink 4 is ejected from the colored ink ejection head so that the liquid level height H2 of the colored ink 4 in the peripheral region of the first region 121 is 70% or more of the liquid level height H1 of the primer 3 in the first region 121 (see FIG. 12). Furthermore, when a width of the first linear region is expressed by WP, the flow distance of the colored ink 4 ejected to the first linear region in step S30 of FIG. 6 (that is, the flow distance of the colored ink 4 ejected on the primer 3) is longer than (WP/2) (see FIG. 47). In other words, the width of the first linear region (the width of the linear pattern 82) is set such that the colored ink 4 ejected at the center in a width direction of the first linear region flows to the region outside the first linear region.

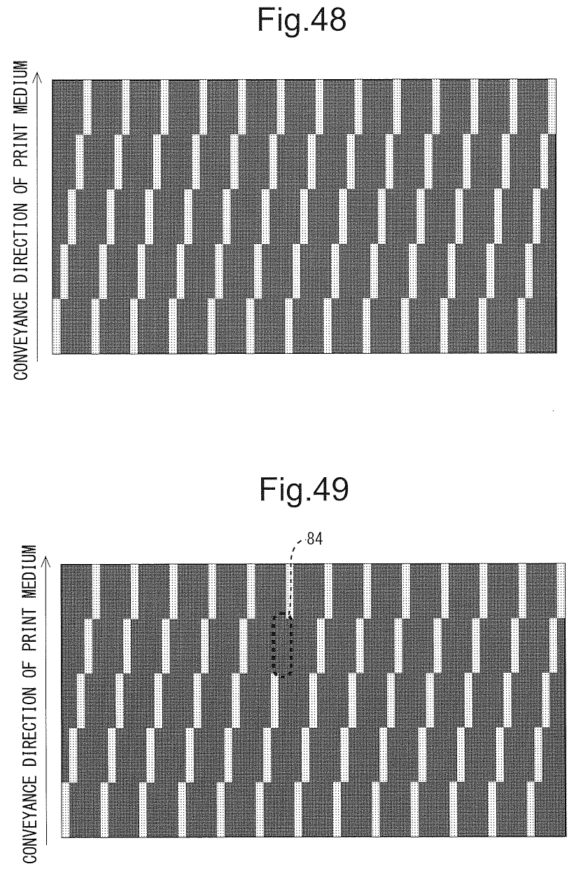

With such a configuration, as in the first embodiment, the layer of the colored ink 4 becomes thinner on the primer 3 than in other regions (the density of the colored ink 4 becomes lower on the primer 3). As a result, in a case where there is no ejection defect nozzle, the print image of the test pattern (ejection defect nozzle detection pattern 80) appearing on the print t medium 12 is schematically as illustrated in FIG. 48. As illustrated in FIG. 48, the region where the stepwise pattern is formed looks thinner than other regions. In a case where an ejection defect nozzle is present, the print image of the test pattern (ejection defect nozzle detection pattern 80) appearing on the print medium 12 is schematically as illustrated in FIG. 49, for example. In the example illustrated in FIG. 49, a dotted line portion denoted by reference sign 84 does not look thin. From this, it can be grasped that ejection defects have occurred in a nozzle that should apply the primer 3 in the dotted line portion denoted by reference sign 84 in FIG. 49.

In a case where the printing rate of the colored ink 4 is set to 5 to 30%, the colored ink 4 is printed with discrete dots. At this time, the contact angle θa of the colored ink 4 on the print medium 12 in the peripheral region of the first region 121 is larger than the contact angle θb of the colored ink 4 on the primer 3 in the first region 121 (see FIG. 31).

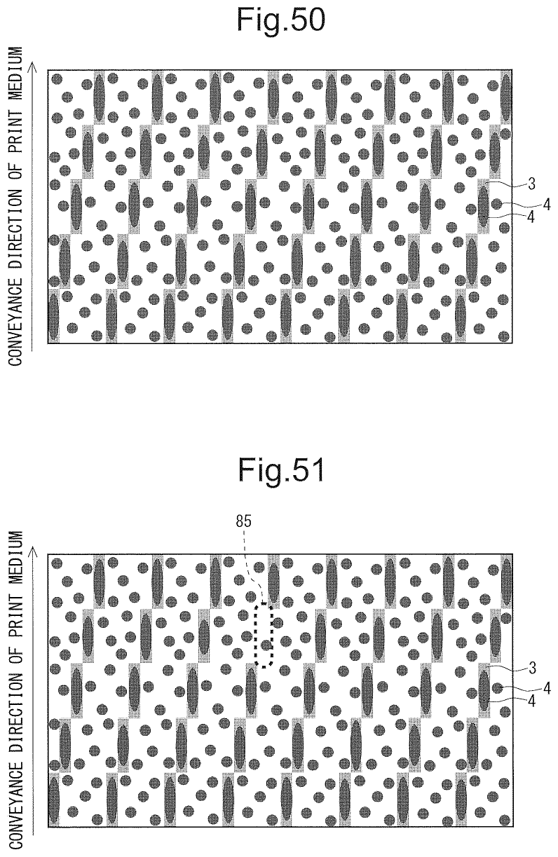

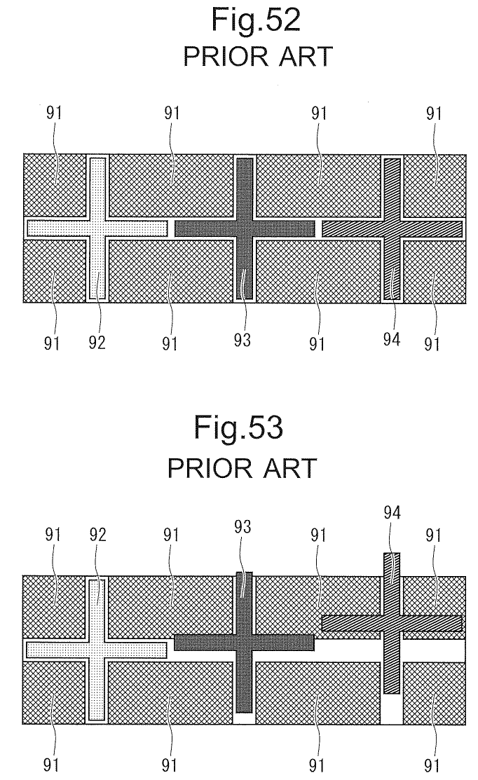

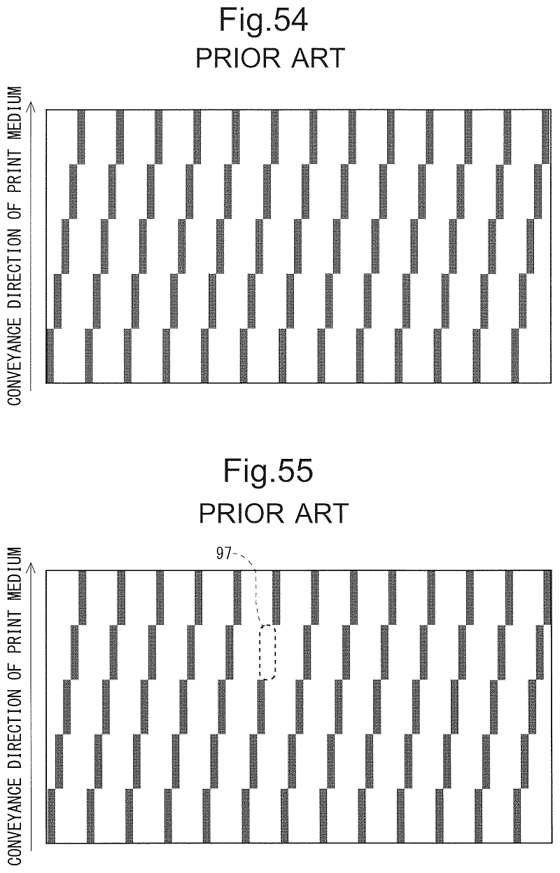

With such a configuration, as in the third embodiment, the colored ink 4 wets and spreads in the first region 121 (that is, on primer 3), whereas the colored ink 4 cures without almost spreading in the peripheral region of the first region 121. As a result, in a case where there is no ejection defect nozzle, the print image of the test pattern (ejection defect nozzle detection pattern 80) appearing on the print medium 12 is schematically as illustrated in FIG. 50. As illustrated in FIG. 50, in the region where the stepwise pattern is formed, the dot diameter of the colored ink 4 is enlarged since the dot of the colored ink 4 overlaps the primer 3. On the other hand, in other regions, the colored ink 4 is directly applied onto the print medium 12. Therefore, the region where the stepwise pattern is formed looks darker than other regions. In a case where an ejection defect nozzle is present, the print image of the test pattern (ejection defect nozzle detection pattern 80) appearing on the print medium 12 is schematically as illustrated in FIG. 51, for example. From the print image illustrated in FIG. 51, it is grasped that ejection defects have occurred in a nozzle that should apply the primer 3 in a dotted line portion denoted by reference sign 85.

### <6. Others>

The present invention is not limited to the above embodiments (including the modifications), and various modifications can be made without departing from the gist of the present invention. For example, although the inkjet printing apparatus of a one-pass system that is provided with a fixed linear print head and performs printing by ejecting ink from the print head while moving the print medium has been exemplified in each of the above embodiments, the present invention is not limited thereto. The present invention can also be applied to a case where an inkjet printing apparatus of a shuttle system that performs printing by ejecting ink from the print head while moving the print head in a paper width direction is adopted.

Note that the present application claims priority to Japanese Patent Application No. 2024-046030 titled “TEST PATTERN FORMING METHOD” filed on Mar. 22, 2024, the content of which is incorporated herein by reference.

What is claimed is:

1. A test pattern forming method of forming a test pattern on a print medium in an inkjet printing apparatus including a colored ink ejection head that ejects a colored ink of ultraviolet curing type and a primer ejection head that ejects a primer of ultraviolet curing type, the test pattern being for inspecting an ejection state of the primer from the primer ejection head, the test pattern forming method comprising:
ejecting the primer from the primer ejection head toward a first region on the print medium;
curing the primer ejected from the primer ejection head with ultraviolet light;
ejecting the colored ink from the colored ink ejection head at a constant ejection amount per unit area toward a second region including the first region and a peripheral region of the first region; and
curing the colored ink ejected from the colored ink ejection head with ultraviolet light,
wherein when a ratio of an amount of the colored ink actually ejected onto the print medium to an amount of the colored ink required to form a solid pattern on the print medium is defined as a printing rate, in the ejecting the colored ink, the colored ink is ejected from the colored ink ejection head such that the printing rate is 70% or more and a height of a liquid level of the colored ink in the peripheral region of the first region is 70% or more of a height of a liquid level of the primer in the first region.

2. The test pattern forming method according to claim 1, wherein
the first region includes a first linear region extending in a conveyance direction of the print medium, and
a flow distance of the colored ink ejected to the first region in the ejecting the colored ink is longer than ½ times a width of the first linear region.

3. The test pattern forming method according to claim 2, wherein
the second region includes a region extending in a direction orthogonal to the conveyance direction of the print medium at a position overlapping with the first linear region, and
the second region includes an index formed at a position adjacent to the first linear region in the conveyance direction of the print medium.

4. The test pattern forming method according to claim 3, wherein the index is a protrusion part or a concave part.

5. The test pattern forming method according to claim 1, wherein
the first region includes a second linear region extending in a direction orthogonal to a conveyance direction of the print medium, and
a flow distance of the colored ink ejected to the first region in the ejecting the colored ink is longer than ½ times a width of the second linear region.

6. The test pattern forming method according to claim 5, wherein
the second region includes a region extending in the conveyance direction of the print medium at a position overlapping with the second linear region, and
the second region includes an index formed at a position adjacent to the second linear region in a direction orthogonal to the conveyance direction of the print medium.

7. The test pattern forming method according to claim 6, wherein the index is a protrusion part or a concave part.

8. The test pattern forming method according to claim 1, wherein
the primer ejection head includes a plurality of nozzles arranged side by side in a direction orthogonal to a conveyance direction of the print medium,
in the ejecting the primer, a plurality of linear patterns respectively corresponding to the plurality of nozzles are formed by ejecting the primer onto the print medium from each of the plurality of nozzles, and
the plurality of linear patterns are formed so as to be separated from each other in the direction orthogonal to the conveyance direction of the print medium.

9. The test pattern forming method according to claim 1, wherein
the first region has a rectangular shape having a first width in a conveyance direction of the print medium and a second width in a direction orthogonal to the conveyance direction of the print medium, and
a flow distance of the colored ink ejected to the first region in the ejecting the colored ink is shorter than ½ times the first width and shorter than ½ times the second width.

10. The test pattern forming method according to claim 1, wherein in the ejecting the colored ink, the colored ink is ejected from the colored ink ejection head so that the printing rate is 200% or less.

11. A test pattern forming method of forming a test pattern on a print medium in an inkjet printing apparatus including a colored ink ejection head that ejects a colored ink of ultraviolet curing type and a primer ejection head that ejects a primer of ultraviolet curing type, the test pattern being for inspecting an ejection state of the primer from the primer ejection head, the test pattern forming method comprising:
ejecting the primer from the primer ejection head toward a first region on the print medium;
curing the primer ejected from the primer ejection head with ultraviolet light;
ejecting the colored ink from the colored ink ejection head at a constant ejection amount per unit area toward a second region including the first region and a peripheral region of the first region; and
curing the colored ink ejected from the colored ink ejection head with ultraviolet light,
wherein when a ratio of an amount of the colored ink actually ejected onto the print medium to an amount of the colored ink required to form a solid pattern on the print medium is defined as a printing rate, in the ejecting the colored ink, the colored ink is ejected from the colored ink ejection head such that the printing rate is 30% or less, and
a contact angle of the colored ink on the print medium in the peripheral region of the first region is larger than a contact angle of the colored ink on the primer in the first region.

12. The test pattern forming method according to claim 11, wherein
the first region includes a first figure extending in a direction orthogonal to a conveyance direction of the print medium, and
a dot diameter, on the print medium in the peripheral region of the first region, of the colored ink ejected from the colored ink ejection head in the ejecting the colored ink is smaller than a width of the first figure.

13. The test pattern forming method according to claim 12, wherein in the ejecting the colored ink, a first index is further formed by ejecting the colored ink from the colored ink ejection head toward a region adjacent to the first figure in the direction orthogonal to the conveyance direction of the print medium.

14. The test pattern forming method according to claim 11, wherein
the first region includes a second figure extending in a conveyance direction of the print medium, and
a dot diameter, on the print medium in the peripheral region of the first region, of the colored ink ejected from the colored ink ejection head in the ejecting the colored ink is smaller than a width of the second figure.

15. The test pattern forming method according to claim 14, wherein in the ejecting the colored ink, a second index is further formed by ejecting the colored ink from the colored ink ejection head toward a region adjacent to the second figure in the conveyance direction of the print medium.

16. The test pattern forming method according to claim 11, wherein
the primer ejection head includes a plurality of nozzles arranged side by side in a direction orthogonal to a conveyance direction of the print medium,
in the ejecting the primer, a plurality of linear patterns respectively corresponding to the plurality of nozzles are formed by ejecting the primer onto the print medium from each of the plurality of nozzles, and
the plurality of linear patterns are formed so as to be separated from each other in the direction orthogonal to the conveyance direction of the print medium.

17. The test pattern forming method according to claim 11, wherein in the ejecting the colored ink, the colored ink is ejected from the colored ink ejection head so that the printing rate is 5 or more.
